(19) United States
(12) Patent Application Publication
(10) Pub. No.: US 2026/0300385 A1
(43) Pub. Date: Oct. 1, 2026

(54) ARTIFICIAL INTELLIGENCE ASSISTED PLATFORM FOR MULTI-FEATURE IMAGE ANALYSIS

(71) Applicant: UNIVERSITY OF WYOMING, Laramie, WY (US)

(72) Inventors: Amin AMOOIE, Windsor, CO (US); Yanbin GONG, Laramie, WY (US); Mohammad PIRI, Laramie, WY (US)

(21) Appl. No.: 19/479,280

(22) PCT Filed: Apr. 26, 2024
(86) PCT No.: PCT/US2024/026437

§ 371 Date: Oct. 27, 2025

Related U.S. Application Data
(60) Provisional application No. 63/462,643, filed on Apr. 28, 2023.

(51) Int. Cl. G06F 16/55; G06T 5/30; G06T 7/11; G06T 7/155

(52) U.S. Cl. CPC G06F 16/55; G06T 5/30; G06T 7/11; G06T 7/155; G06T 2207/20036; G06T 2207/30204

(57) ABSTRACT

A method and system for image processing are disclosed. The methods and systems include obtaining a set of images of at least one porous media sample. At least one of adaptive local thresholding, automated global thresholding, and morphological operations are applied to one or more of the set of images. Based on the applying, a set of macro-pores are masked within the at least one porous media sample using an estimate of the set of macro-pores. The estimate for each of the set of macro-pores represents a segment of the at least one porous media sample. A set of clusters generated based, at least in part, on the masking are obtained. A marker-controlled watershed segmentation procedure is applied to the set of clusters.

### BACKGROUND

### Field

Aspects of the present disclosure generally relate to imaging of porous media, and more particularly, to image processing for porous media samples.

### Description of the Related Art

Modeling techniques for fluid flow through porous media are broadly implemented for petroleum resource development, materials engineering, food packaging, and medical technology development. Fluid flow modeling techniques may be equipped to illustrate both physical and chemical media properties like permeability, capillary pressure, fluid saturation, contact angle, wettability, or other similar properties, which may be used to characterize fluid behavior.

Although current techniques for modeling fluid flow through porous media are based on technological advancements made over many years, resultant models may still be tenuous representations of actual porous media. For example, fluid flow models of porous media exceeding a few millimeters may require a lower resolution implementation to match currently available computational capabilities. As a result, fluid flow models based on porous media of a larger scale may not accurately reflect physical and chemical properties of the media. Accordingly, there is an impetus to improve the accuracy of fluid flow modeling, including, for example: improving image processing techniques to allow for higher resolution model input and model output, improving image processing techniques to allow for more accurate model input and model output, enhancing computational processing capability to reduce computational expense, enhancing computational processing capability increase modeling speed, increasing automation for iterative modeling steps, improving model capability for dynamic modeling of different fluid flow environments, improving model capability for dynamic modeling of larger fluid flow environments, and the like.

Consequently, there exists a need for further improvements in fluid flow modeling of porous media to overcome the aforementioned technical challenges and other challenges not mentioned.

### SUMMARY

One aspect of the present disclosure provides a method for image processing by one or more central processing units (CPU). The method may include obtaining a set of images of at least one porous media sample. At least one of adaptive local thresholding, automated global thresholding, and morphological operations are applied to one or more of the set of images. Based on the applying, a set of macro-pores are masked within the at least one porous media sample using an estimate of the set of macro-pores. The estimate for each of the set of macro-pores represents a segment of the at least one porous media sample. A set of clusters generated based, at least in part, on the masking are obtained. A marker-controlled watershed segmentation procedure is applied to the set of clusters.

One aspect provides a non-transitory computer-readable medium comprising computer-executable instructions that, when executed by one or more processors, cause one or more CPUs to perform a method of image processing. The method may include obtaining a set of images of at least one porous media sample. At least one of adaptive local thresholding, automated global thresholding, and morphological operations are applied to one or more of the set of images. Based on the applying, a set of macro-pores are masked within the at least one porous media sample using an estimate of the set of macro-pores. The estimate for each of the set of macro-pores represents a segment of the at least one porous media sample. A set of clusters generated based, at least in part, on the masking are obtained. A marker-controlled watershed segmentation procedure is applied to the set of clusters.

Another aspect provides an apparatus. The apparatus for image processing includes a memory and one or more central processing units (CPU), the one or more CPUs configured to cause the apparatus to obtain a set of images of at least one porous media sample. At least one of adaptive local thresholding, automated global thresholding, and morphological operations are applied to one or more of the set of images. Based on the applying, a set of macro-pores are masked within the at least one porous media sample using an estimate of the set of macro-pores. The estimate for each of the set of macro-pores represents a segment of the at least one porous media sample. A set of clusters generated based, at least in part, on the masking are obtained. A marker-controlled watershed segmentation procedure is applied to the set of clusters.

### BRIEF DESCRIPTION OF THE DRAWINGS

So that the manner in which the above recited features of the present disclosure can be understood in detail, a more particular description of the disclosure, briefly summarized above, may be had by reference to aspects, some of which are illustrated in the appended drawings. It is to be noted, however, that the appended drawings illustrate only example aspects and are therefore not to be considered limiting of its scope, may admit to other equally effective aspects.

FIG. 1A example pore network representation overlaid with a segmented micro-CT image, according to embodiments.

FIG. 1B depicts an example high-resolution porous media images taken by a scanning instrument from a single rock sample and segmented for characterization, according to embodiments.

FIG. 2 depicts an example core-flooding instrument for determining the physical and chemical characteristics of a porous media sample, according to embodiments.

FIG. 3A illustrates a histogram of a noisy micro-CT image, according to embodiments.

FIG. 3B illustrates the noisy micro-CT image, according to embodiments.

FIGS. 3C and 3D illustrate a high threshold case, according to embodiments.

FIGS. 3E and 3F illustrate a low threshold case, according to embodiments.

FIG. 4A is a pixel count histogram for the raw image slice, according to embodiments.

FIG. 4B is the raw image slice, according to embodiments.

FIG. 4C illustrates an overlap of the segmentation portions, according to embodiments.

FIG. 4D illustrates another portion of segmentation, according to embodiments.

FIG. 4E illustrates one portion of segmentation, according to embodiments.

FIG. 5A illustrates a Phase 1, a Phase 2, and a Phase 3, according to embodiments.

FIG. 5B shows a quantized image superimposed with phase boundaries, according to embodiments.

FIG. 5B shows a hypothetical trinary classification of the quantized image, according to embodiments.

FIG. 5D shows a final segmented image with each segment associated with one of the classes, according to embodiments.

FIG. 6 depicts an example image processing platform procedure for images of porous media by a central processing unit (CPU) and a graphics processing unit (GPU), according to embodiments.

FIG. 7 depicts an example to non-local means filtering applied to a raw image of a porous media sample, according to embodiments.

FIG. 8A shows a raw noisy micro-CT image, according to embodiments.

FIG. 8B shows a de-noised image using GPU-accelerated non-local means filtering implemented in the platform, according to embodiments.

FIG. 9A shows the de-noised image using GPU-accelerated non-local means filtering implemented in the platform, according to embodiments.

FIG. 9B and FIG. 9C show the adaptive local thresholding, according to embodiments.

FIG. 9D and FIG. 9E show manual thresholding, according to embodiments.

FIG. 10 depicts an example procedure for enhancing features of a porous media image, according to embodiments.

FIG. 11 depicts an example adaptive local thresholding workflow, according to embodiments.

FIGS. 12A-12E depicts an example k-means clustering workflow, according to embodiments.

FIG. 13 depicts an example workflow to refine an extracted phase from a trinary image, according to embodiments.

FIG. 14A shows the gray-scale de-noised image, according to embodiments.

FIG. 14B shows the stitched de-noised image, according to embodiments.

FIGS. 15A-15H illustrate the implemented steps to obtain markers for sure macro-pore region, according to embodiments.

FIG. 16 depicts example definite regions for the intermediate phase, according to embodiments.

FIG. 17A illustrates a histogram of an 8-bit gray scale image, according to embodiments.

FIG. 17B illustrates the grain portion (light gray) of the 8-bit gray scale image, according to embodiments.

FIG. 17C illustrates the pore portion (white) of the 8-bit gray scale image, according to embodiments.

FIG. 18A illustrates pore portion of the 8-bit gray scale image, according to embodiments.

FIG. 18B illustrates mid-phase portion of the 8-bit gray scale image, according to embodiments.

FIG. 18C illustrates grain portion of the 8-bit gray scale image, according to embodiments.

FIG. 18D illustrates composite image of the pore portion, mid-phase portion, and grain portion of the 8-bit gray scale image, according to embodiments.

FIG. 19A illustrates the 8-bit grayscale image, according to embodiments.

FIG. 19B illustrates a watershed-based workflow, according to embodiments.

FIG. 19C illustrates a non-watershed-based workflow, according to embodiments.

FIG. 20A illustrates a watershed-based workflow with a compactness level of 1, according to embodiments.

FIG. 20B is illustrates a watershed-based workflow with a compactness level of 10, according to embodiments.

FIG. 20C illustrates a watershed-based workflow with a compactness level of 50, according to embodiments, according to embodiments.

FIG. 21 illustrates the effects of k-means clustering using an image processing platform to facilitate higher-dimensional clustering and subsequent merging of clusters to construct trinary segmentation images, according to embodiments.

FIG. 22A illustrates data derived from the elbow method to obtain a k value, according to embodiments.

FIG. 22B illustrates data derived from the silhouette method to obtain a k value, according to embodiments.

FIG. 22C illustrates a histogram of the the 8-bit grayscale image, according to embodiments.

FIG. 22D illustrates the 8-bit grayscale image of FIG. 22C, according to embodiments.

FIG. 22E illustrates an 8-bit grayscale image of a k-means clustering determination of the porosity of an intermediate phase, according to embodiments.

FIG. 22F illustrates an 8-bit grayscale image of a k-means clustering determination of the porosity of an intermediate phase, according to embodiments, according to embodiments.

FIG. 22G illustrates an 8-bit grayscale image of a k-means clustering determination of the porosity of an intermediate phase, according to embodiments, according to embodiments.

FIG. 23 illustrates a schematic of a parallel processing workflow, according to embodiments.

FIG. 24 illustrates a hierarchical hardware mapping between CPUs and GPUs adopted for heterogeneous compute nodes, according to embodiments.

FIG. 25A is a graph illustrating a stand-alone micro porosity evaluation of the impact of stack size on the 3D watershed-based segmentation with respect to the mid-plane slice within the stack, according to embodiments.

FIG. 25B is a graph illustrating a stand-alone macro porosity evaluation of the impact of stack size on the 3D watershed-based segmentation with respect to the mid-plane slice within the stack, according to embodiments.

FIG. 26 illustrates a hierarchical hardware mapping between CPUs and GPUs adopted for 3D segmentation and trinary image processing, according to embodiments.

FIG. 27 illustrates the quantitative results from micro-CT images acquired from a sandstone reservoir core sample generated by the methods described herein, according to embodiments.

FIG. 28 is a graph illustrating a porosity profile measured quantities along the core of a porous media sample, according to embodiments.

FIG. 29 depicts voxel-size subvolumes illustrating a preprocessed and filtered volume as well as a trinary image result from a 3D segmentation and an extracted intermediate phase with the micro-porosity, according to embodiments.

FIG. 30 depicts a method for processing images of porous media by one or more CPUs, according to embodiments.

FIG. 31 depicts a method 3100 for multiscale imaging of porous media by one or more GPUs, according to embodiments.

FIG. 32 is an example device for imaging of porous media, according to embodiments.

To facilitate understanding, identical reference numerals have been used, where possible, to designate identical elements that are common to the figures. It is contemplated that elements and features of one aspect may be beneficially incorporated in other aspects without further recitation.

### DETAILED DESCRIPTION

In the following, reference is made to aspects of the disclosure. However, it should be understood that the disclosure is not limited to specifically aspects described. Instead, any combination of the following features and elements, whether related to different aspects or not, is contemplated to implement and practice the disclosure. Furthermore, although aspects of the disclosure may achieve advantages over other possible solutions and/or over the prior art, whether or not a particular advantage is achieved by a given aspect is not limiting of the disclosure. Thus, the following aspects, features, aspects, and advantages are merely illustrative and are not considered elements or limitations of the appended claims except where explicitly recited in a claim(s). Likewise, a reference to “the disclosure” shall not be construed as a generalization of any inventive subject matter disclosed herein and shall not be considered to be an element or limitation of the appended claims except where explicitly recited in a claim(s).

The present disclosure relates to techniques for high-reliability image processing of porous media. Specifically, the techniques discussed herein may be implemented for use in processing accurate, high-resolution images of porous media to produce reliable digital replicates of any porous medium. The porous media may comprise a digital rock sample, a core sample, a plastic sample, a tissue sample, or any other organic or inorganic sample having pore space ascertainable through imaging techniques.

A thorough grasp of fluid flow through pore networks of material with substantial pore space may be consequential to enhancing technical efficacy of fluid flow techniques in a wide range of industries. Models of fluid flow through a porous material may be used to describe physical and chemical characteristic of the material. Such models may help to highlight optimal usage for a certain porous material. In many cases, networks of pores within a material are extremely small, ranging from microscale to nanoscale in size. Techniques for characterizing these pore networks are hindered by the computational expense of modeling at a nanoscale. Often, to alleviate computational burdens, pore network modeling techniques use lower resolution images at the expense of model accuracy. Extrapolation errors caused by low resolution characterization may result in mischaracterization of physical and chemical characteristics of the porous material. Accordingly, ideal modeling of fluid flow through porous media would allow for rapid, accurate nanoscale imaging that may be performed without inhibitive computational expense.

According to certain aspects of the present disclosure, high-reliability image processing of porous material may be achieved through multi-image analysis performed by processing systems operating in parallel. Specifically, overlapping high-resolution images of a porous material, may be obtained by a scanning instrument (e.g., a micro-computed tomography (CT) scanner), stitched together where the images overlap, and processed to obtain a super-resolution image of the porous material. Stitching procedures may be split across one or more central processing units (CPUs) and/or one or more graphics processing units (GPUs) in a parallel processing architecture. This may allow faster, more accurate modeling of porosity information without loss of vital micro-porosity detail.

Implementation of techniques for obtaining reliable digital replicates of porous media samples as described herein may enhance pore network modeling functionality by reducing porous material characterization errors to the benefit of all users seeking a more comprehensive understanding of any given porous material.

### Introduction to Pore Network Modeling

Modeling techniques for fluid flow through porous media may illustrate both physical and chemical porous media properties. Models of porous media may be used to ascertain permeability, capillary pressure, fluid saturation, wettability, buoyancy, and the like to a greater degree of accuracy comparable to physical flooding of a porous media sample. Additionally, physical and chemical properties determined using pore network modeling techniques may be used to characterize in-situ fluid behavior as it travels through the porous media under a wide variety of wettability and flooding conditions. These conditions may not be accessible to users performing conventional physical flooding characterization techniques.

Permeability is the tendency of the porous media to allow liquids to flow through it. Capillary pressure is the pressure difference existing across the interface separating two immiscible fluids. Fluid saturation is the measurement of fluid present in the pore spaces of the porous media. Contact angle is a measured angle between a fluid-fluid or a fluid-gas interface at a point where it meets a solid surface. Wettability is the ability of a liquid to maintain contact with a solid surface. Wettability may vary depending on wettability conditions and the type of wetting liquid present in the porous media sample. For example, a water-wet medium may show a lower wetting affinity to the oil phase than an oil-wet medium, where higher or lower wetting is determined with respect to a given phase. In certain cases, the correlation between wettability and viscosity ratio may not be straightforward, as there may be water or oil wet conditions with similar viscosities.

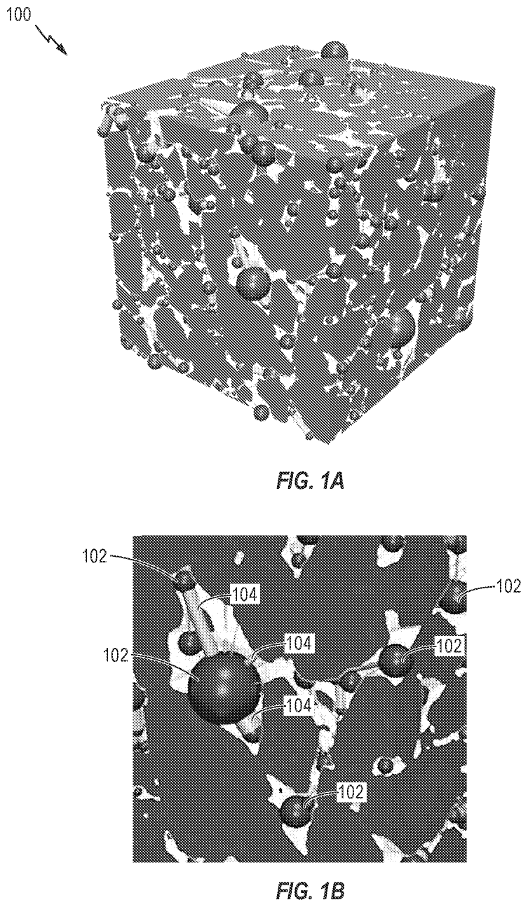

A modeled pore network is a practical description of a porous medium targeted for fluid flow modeling. FIG. 1A example pore network representation overlaid with a segmented micro-CT image. The example pore network is extracted from porous sandstone. The section of the pore network describes the porosities of various size and shape present in that portion of the sandstone and may be used to model fluid flow through those porosities for various wettability conditions. Three-dimensional (3D) portions of a pore network model may more accurately characterize the porous media sample either alone or in combination with other 3D portions of the pore network model.

Dynamic pore network models (e.g., of FIG. 1A) may be extracted from images of a targeted porous medium and used to model multi-phase fluid flow using physically based displacement mechanisms (PBDMs) across pores defined in a pore network. PBDMs may represent an estimated displacement of a modeled fluid in response to movement of another fluid or gas within the pore network. As immiscible phases react with one another throughout the pore network during fluid flooding, PBDMs are induced where, for example, capillary pressure across a meniscus exceeds the wettability constraints on either phase. Fluid saturation, contact angle, buoyancy, and the like may also affect PBDMs throughout a pore network. By utilizing a pore network model extracted from a porous media sample, a user may be able to ascertain PBDMs through the porous media sample under a wide variety of wettability conditions in order to ultimately obtain, for example, useful permeabilities for a larger sample of the porous medium without degrading a porous media sample via repeated physical flooding.

FIG. 1B depicts an example high-resolution porous media images taken by a scanning instrument from a single rock sample and segmented for characterization. To properly generate PBDMs at a pore scale for the targeted porous media, imaging may capture complex geometries of the targeted porous media at a resolution sufficiently high to retain acceptable accuracy. Pores may be defined as a complex polyhedron having at least a center 102 and spherical and effective diameters. Connective throats 104 between pores may also be defined. In many cases, image resolution may be in micrometers or nanometers to capture applicable pore detail. High-resolution pore models allow for accurate rendering of the fluid flow characteristics described above as ascertained at each pore and for each PBDM.

PBDMs may occur upon flooding or draining of a dynamic pore network model, where aqueous phase injection or removal is iteratively simulated through the pore network. Aqueous flooding and aqueous draining may be implemented in various modeled wettability conditions, where certain fluids are present prior to the start of a simulation. Wettability conditions may include at least water-wet, oil-wet, or mixed-wet conditions. During aqueous flooding, injected water may displace immiscible fluid preexisting in the pore network model. During aqueous draining, injected immiscible fluid may displace water preexisting in the pore network model. In certain cases, flooding and draining may be fluid flooding and fluid draining. In some cases, fluid may be oil.

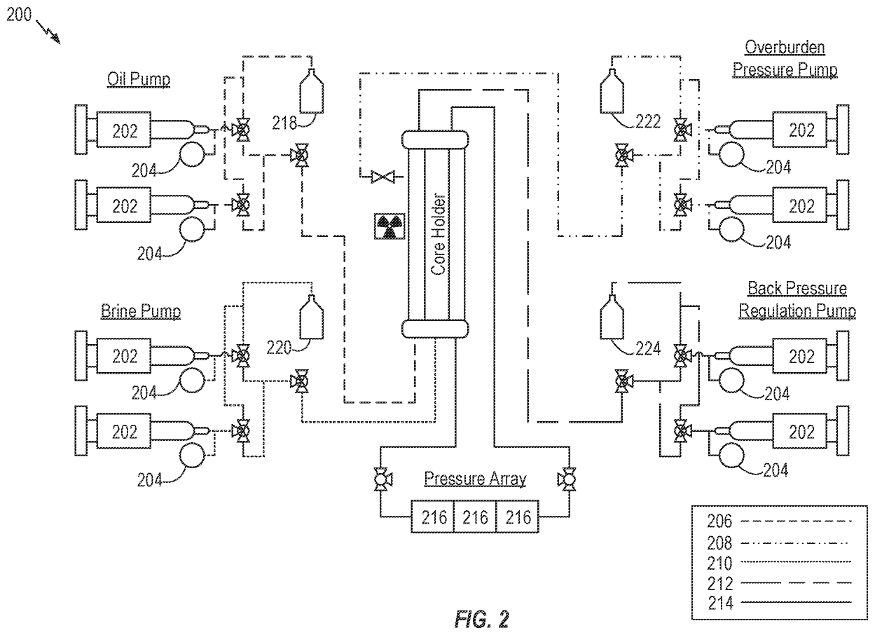

Flooding or draining of a dynamic pore network model may be simulated based in part on scanned images of physical flooding implemented by a flooding instrument 200 of FIG. 2. In some cases, a porous media may undergo a core-flooding experiment to establish an irreducible water saturation, a residual oil saturation, or both. Core-flooding may be enabled by a set of pumps 202, rupture disks 204, pump lines 206-214, differential pressure transducers 216, and source buckets 218-222 working in tandem to flood a porous media sample loaded in a core holder. In some cases, a scanning instrument (e.g., a micro computed tomography (micro-CT) scanner) captures a dry reference image prior to flooding. Scanning occurs in a field of view defined within the core holder. In some cases, the porous media sample may be flooded with brine from bucket 220 via the brine tubing line 206 and scanned again to ensure that the porous media sample is fully saturated. Once the brine flooding is complete, the absolute permeability of the porous media sample may be obtained. The oil flooding may be performed alongside additional brine flooding. Any fluid expelled as a result of overburden pressure (i.e., pressure that compacts pore space and reduces permeability) may be transported via the confining fluid line 208 and collected in bucket 222. Any fluid expelled as a result of the flooding procedure may be transported via the effluent fluid line 212 and collected in bucket 224. In many cases, core sample pressure may be iteratively adjusted during flooding. Pressure may be recorded by one or more differential pressure transducers 216 coupled to the core holder via a transducer line 214.

FIG. 2 depicts an example core-flooding instrument for determining the physical and chemical characteristics of a porous media sample. Scanned images obtained from flooding procedures performed by the flooding instrument 200 may be used to extract a pore map representative of the porous media sample. The images may be processed to determine characteristics of fluid flow through the porous media sample. In many cases, the images may also be used to extract a representative pore network model.

Imaging of porous media is typically performed using micro-CT imaging. In many cases, commercial micro-CT scanners (e.g., Zeiss scanners) are available for imaging necessary to perform pore network modeling. Images of porous media taken by micro-CT scanners are at a sufficiently high resolution to create a microscale digital image of the porous media.

In the current state of the art, there exists a challenge of extracting porous media characteristics in a manner precise and repeatable to ensure the ultimate stability of future simulations. Currently, techniques for porous media characterization require lengthy step-wise processing known to incur undue computational expense and introduce instability to characterization of the porous media sample. As a result, users may not be able to rely on characterization output to simulate flow conditions in a useful way.

### Aspects Related to Multiscale Imaging for Porous Media

In the current state of the art, there exists a challenge of predicting fluid flow through porous media in a manner precise and repeatable to ensure the ultimate stability of future simulations. Currently, techniques for two-phase fluid flow prediction require lengthy step-wise processing known to incur undue computational expense and introduce instability to characterization of the porous media sample. As a result, users may not be able to rely on characterization output to simulate flow conditions in a useful way.

Fluid flow modeling through porous media is often utilized to enhance petroleum resource development. In recent years, global demand for energy resources has mobilized development of petroleum reservoirs as targets for hydrocarbon extraction. The geological formations that comprise these hydrocarbon reservoirs are ultra-tight shale formations resistant to primary petroleum extraction techniques. A matrix of an ultra-tight shale reservoir may be characterized by low permeability and low porosity. To extract hydrocarbons from the ultra-tight shale matrix, secondary and tertiary petroleum extraction techniques seek to maximize oil production through the microscale pore networks that comprise a substantial amount of the porosity in the shale matrix.

A robust understanding of fluid flow through microscale pore networks of unconventional reservoirs may be consequential to extracting the trillions of barrels of oil still housed in shale formations globally. Models of fluid flow through a pore network that describe permeability, capillary pressure, fluid saturation, and wettability may help to elucidate specific steps to be taken during resource development to optimize petroleum production. Even so, techniques for characterizing these microscale pore networks are hindered by the computational expense of modeling sub-resolution pore network and extrapolation errors caused by unstable characterization of pore geometries.

As discussed above, ideal modeling of fluid flow through porous media would allow for high resolution imaging of a macro-sized porous media sample. In a case where the porous media sample is, for example, a cylindrical core sample of a rock having a length of six inches and a diameter of one inch, the core sample is likely to have porosity and permeability that vary across its length and width. This is common in core samples, and especially in core samples representative of ultra-tight oil formations. Geological processes that form certain oil-bearing rocks can produce heterogeneous morphological features in the rock that may be present even at a nanometer scale. This is especially true for oil bearing carbonate rocks, which contain micro-porosities that contribute significantly to the overall porosity of the rock. These nanoscale morphological features may affect the pore network of the core sample, altering the porosity and permeability throughout a core sample. Thus, accurate characterization of fluid flow through a core sample may depend on nanoscale resolution sufficient to detect heterogeneous properties of a pore network.

Numerical computation from high-resolution 3D micro-tomographic images of rocks, also known as Digital Rock Technologies (DRT), has the potential to more accurately and faithfully predict the underlying petrophysical properties and macroscopic flow behavior of fluids within such porous media. The first component of DRT is image processing of micro-CT images, which may entail processing of images obtained by micro-CT scanner in the lab. Ideally, DRT may accurately and efficiently render and process the obtained image datasets, which may allow a user to obtaining reliable digital replicates that are in one-to-one correspondence to the rock samples. However, in the current state of the art, DRT is limited to samples with simple structure and mineralogy and is disadvantaged by low computational efficiency, ultimately making DRT less than desirable to process large image datasets (high resolutions and/or large physical sample sizes). Additionally, the majority of existing attempts require continuous end-user input and interaction for each case. This prevents scaling out by preventing automated execution and batch processing of a number of cases. There also exists a challenge in processing multi-mineral rocks that are presented using grayscale values of different minerals in micro-CT images, because those value are often very similar.

Here, we propose a practical image processing platform built to take advantage of parallel processing on both multi-CPU and multi-GPU threads. In addition, the image processing platform may utilize machine learning to aid in the segmentation workflow. Techniques described herein may be applied to complex porous media. For example, the image processing platform may produce reliable digital replicates for complex rocks such as carbonates or sandstones. Sandstones contain mostly quartz and a variable fraction of dispersed clay and other minerals that collectively host micro-pores that are not fully resolved by the image resolution. The image processing platform may output a three-label segmentation of porous media images that detect macro-pores (resolved fully by scanner), intermediate phases containing micro-porosity, and dominant grain minerals. Furthermore, the platform may infer the total fraction of micro-porosity hosted within the intermediate phase.

Aspects of the present disclosure describe an image processing platform for multi-component (e.g., multi-mineral rock) image analysis using an artificial intelligence (AI)-assisted approach with automated GPU-accelerated workflows. Aspects of the present disclosure provide techniques for processing images obtained by a micro-CT scanner in the lab, and rendering and processing image datasets to obtaining reliable digital replicates that are in one-to-one correspondence to the porous media samples (e.g., studied in the laboratory). Aspects of the present disclosure further provide techniques to visualize and massively process raw 3D images of a wide range of porous media materials while using the computational power of multi-core, multi-GPU systems through domain decomposition techniques.

The image processing platform may include preprocessing and image enhancement, which may use an efficient variant of nonlocal means filtering accelerated on one or more GPUs, followed by a segmentation workflow. The segmentation workflow may consist of two major components. The first component may configure one or more CPUs and/or one or more GPUs to perform adaptive local thresholding, automated global thresholding, top-hat transformation of raw image, and several morphological operations to obtain a conservative estimate of macro-pores as one segment in the raw micro-CT image of the porous media sample (e.g., a rock sample). Next, the one or more CPUs and/or the one or more GPUs may perform GPU-accelerated clustering on an image masked by the one or more CPUs to find the segments for grains within the porous media sample having a certain composition (e.g., minerals like clay that can host micro-porosity but are often not resolved by the imaging resolution). This clustering-based multi-mineral segmentation of porous media may include training a model based on a portion of pixels in each image slice. The trained model may be used to predict the cluster centroids to which each pixel of the image belongs. After applying the trained model, a merging process may take place to merge like components of the porous media sample. For example, detected minerals may be merged into a more representative ‘grain’ cluster and the micro-porosity-containing minerals into an intermediate ‘clay’ phase. A three-class segmentation may be obtained, and the corresponding three-class markers may be generated following automated workflows, which may conservatively represent ‘definite’ classes (e.g., pores, clays, and grains). The first component of the platform may be performed for all the slices of a 3D stack in parallel using multi-core CPU threads as well as multi-GPUs at the same time. This may facilitate increased processing speeds.

In the second component of the workflow, a variant of marker-controlled 3D watershed segmentation may be performed. The watershed segmentation employs a compactness parameter to regularize the regional seed growth. Due to the extremely high computational load of performing 3D watershed-based segmentation for the entire stack, a parallel version may be implemented to simultaneously perform the segmentation on multiple partially overlapping subvolumes with certain subvolume and pad sizes determined a priori to eliminate the end effect at the margins of each vertical subvolume. This approach may significantly reduce computational time for a typical gray-scale image stack (e.g., containing 2000 slices with each slice comprising about 9 million pixels). Marker-controlled watershed segmentation may allow full connectivity to be maintained in 3D space for each of the defined classes.

Image segmentation may fail under spatial distribution of noise and poor contrast and brightness. Image filtering (de-noising) may be an important part of image processing because it helps to improve the visual quality of images by removing unwanted artifacts or noise. Random noise can be caused by factors such as a low-quality camera, transmission errors, or other environmental factors. The challenge, however, is to smooth an image and remove high-frequency noise while preserving the edges and important features of the image. This is particularly important for the application of porous rock image processing since such features are crucial to maintain the connectivity in the space that serves as fluid conduit during fluid flow simulations.

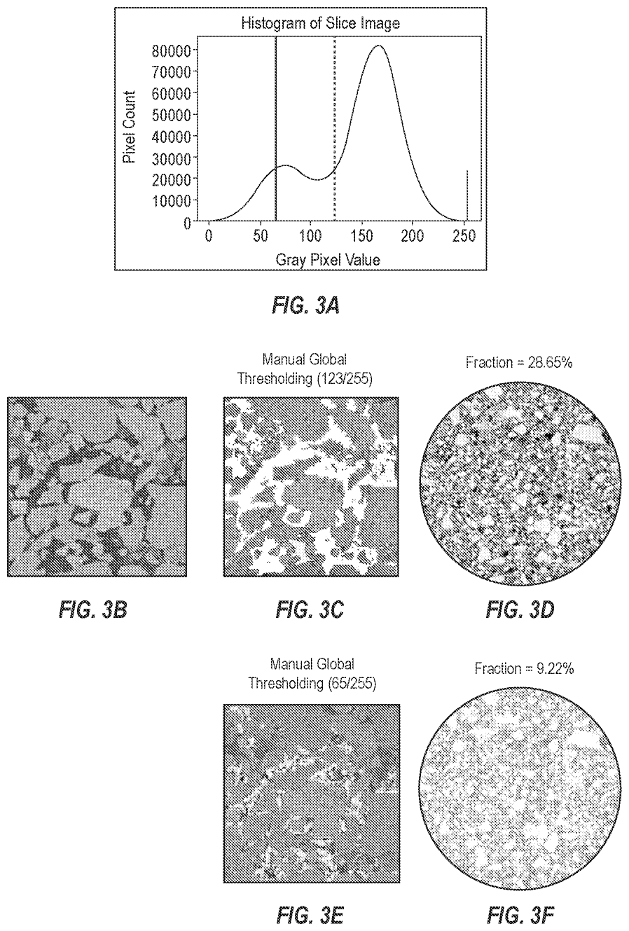

FIG. 3A illustrates a histogram of a noisy micro-CT image. FIG. 3B illustrates the noisy micro-CT image. FIGS. 3C and 3D illustrate a high threshold case. FIGS. 3E and 3F illustrate a low threshold case. The illustration of segmentation behavior on a noisy micro-CT image in FIGS. 3A-3F provides an example of how applying a simple segmentation on a noisy image may result in an over-segmented and/or under-segmented image result based on different chosen thresholds. This may occur, in part, because the histogram of the gray-scale intensity (FIG. 3A) cannot show a distinct bimodal distribution with one mode associated with pores and the other associated with grain. Instead, the noise that exists within the pore region skews their frequency towards grain while the noise in grain region shifts they frequency towards pores. As a result, a significant overlap between the two segments may exist in a noisy image in both high threshold cases (FIGS. 3C and 3D) and low threshold cases (FIGS. 3E and 3F). In particular, it may not be practical to segment an intermediate phase out due to the intertwined intensities of main two modes.

Typically, the image processing workflow under DRT applications may follow a standard threshold-based image segmentation protocol. This standard protocol proceeds according to a global thresholding where the user may select the threshold manually or use existing automatic methods, then inspect the results in an interactive manner to find the most optimal threshold. While this method may be sufficient for binary (e.g., two-label) segmentation of less complex porous media (e.g., less noisy, regularly shaped grains and pores, low intermediate phase content), it cannot work for trinary (e.g., three-label) segmentation, especially for more complex and heterogeneous cases.

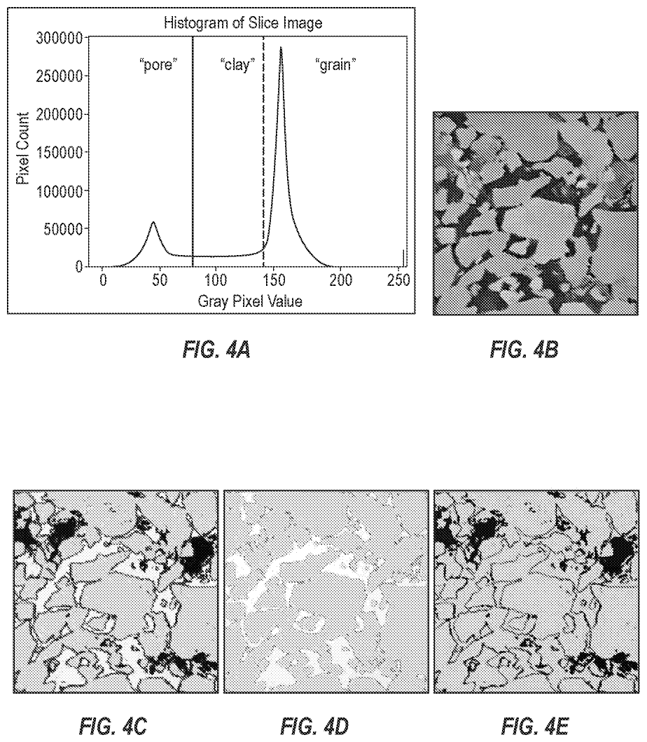

Aspects of the present disclosure provide a threshold-based trinary segmentation on a scanned image of a porous media sample. An example of trinary segmentation is illustrated in FIGS. 4A-4E, which shows trinary segmentation performed on a typical sandstone reservoir core sample. The segmentation example uses three-phase segmentation using Automatic Maximum Entropy Multi-Threshold segmentation technique. Three classes are obtained, which represent the macro-pore (“pore”), intermediate mineral phase that contain micro-pores (“clay”), and other predominant mineral grains (“grain”). FIG. 4B is the raw image slice. FIG. 4A is a pixel count histogram for the raw image slice. FIG. 4E illustrates one portion of segmentation. FIG. 4D illustrates another portion of segmentation. FIG. 4C illustrates an overlap of the segmentation portions. The thresholds of FIGS. 4A-4E are obtained by applying an automatic maximum entropy multi-threshold technique that works based on the intensity of the gray levels and is designed to maximize the entropy between class distributions.

In some cases, global thresholding may be insensitive to localized variation in gray levels within pore to clay transition zones. Hence, segmented invadable/macro-pores may be over-estimated due to the likely inclusion of micro-porosity. Transition between actual pores and grain regions (e.g., connectivities and corners) are likely to be missed under such global thresholding. Opting for lower pore thresholds to mitigate the first problem might make the current problem more severe while causing non-uniformity and holes in the pore segmented regions. Phase boundaries (visible in FIG. 4E) are classified as intermediate phase (e.g., based on intensity values), but may belong to one of the surrounding pore or grain phases. This misidentification may cause over-estimation of the middle segment (e.g., clay content and total porosity).

This misidentification may be referred to as partial volume effect, occurring on account of quantized or pixelated nature of digital images. Specifically, partial volume effect may result in mixed voxels that contain two phases that would have been assigned a separate pure pixel if the resolution were higher. The intensity values for such pixels fall in the middle of two main modes and as such they can be categorized as the intermediate phase associated with this range of intensities.

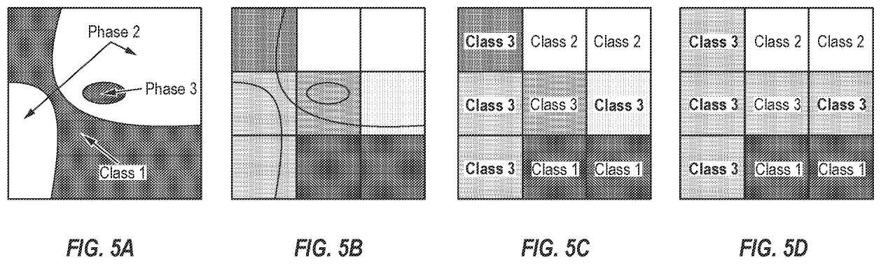

The partial volume effect is schematically illustrated in FIGS. 5A-5D. FIG. 5A illustrates a Phase 1, a Phase 2, and a Phase 3. Phase 1 represents the macro-pores. Phase 2 represents the grains. Phase 3 represents the micro-pores that are assumed to be not fully resolved by the resolution of the digital image. FIG. 5B shows the quantized image superimposed with phase boundaries. FIG. 5C shows the hypothetical trinary classification of the quantized image. FIG. 5D shows the final segmented image with each segment associated with one of the classes. While Class 1 and Class 2 pixels correctly represents Phase 1 and Phase 2, respectively, Class 3 represents the mixed pixels that are composed of both Phase 1 and 2 as well as pixels that contain Phase 3. In some cases, the pixel that surrounds the entire Phase 3 includes Phase 2 as well, which mimics the fact that micro-pores are hosted by clay minerals according to a trinary segmentation. While the center pixel may be correctly labeled as Class 3, the other pixels labeled Class 3 may be artifacts due to the partial volume effect, ultimately causing the over-estimation of intermediate segment. Techniques described herein may circumvent this issue.

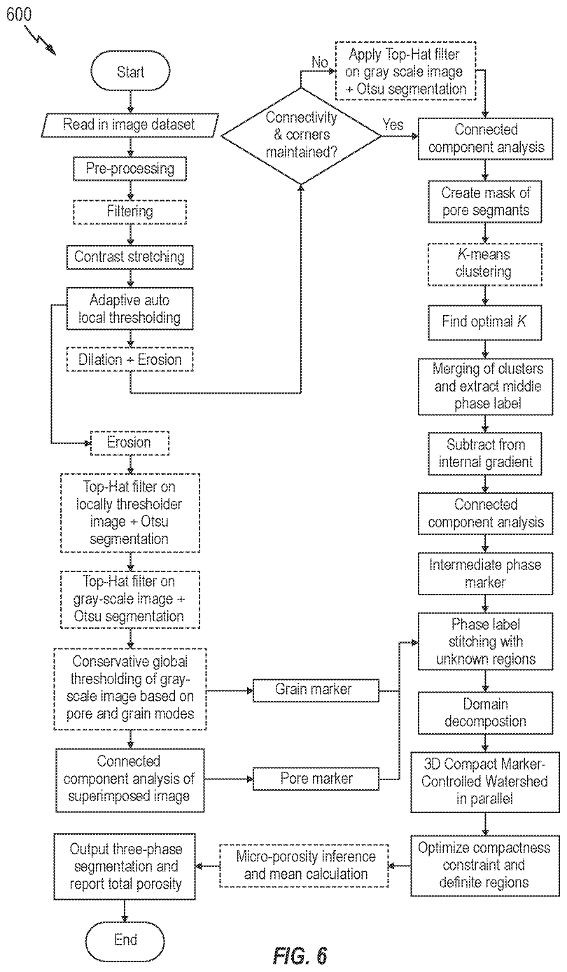

FIG. 6 depicts an example image processing platform procedure 600 for images of porous media by a central processing unit (CPU) and a graphics processing unit (GPU). The image processing platform procedure 600 that may enable trinary segmentation. The steps in solid boxes are performed by one or more CPUs. The steps in dashed boxes are GPU-accelerated processes applied during image processing platform using one or more GPUs. The image processing platform workflow starts by reading the image dataset. Using the global histogram of the entire image stack, the intensities of each slice are normalized to obtain a uniform intensity across the length of the core. The platform adopts a GPU-accelerated nonlocal means filtering technique to execute image processing functions on the GPUs. The one or more CPUs implement this module to further optimize the parameters by minimizing the peak signal-to-noise ratio (PSNR) of the noisy image relative to de-noised image. The structural similarity index measure (SSIM) is also used to estimate the perceived quality of the de-noised image relative to original noisy image as well as reference filtered image if available. The image processing platform is designed to leverage multi-GPU systems and executes the filtering of batches of images on multiple GPUs in parallel.

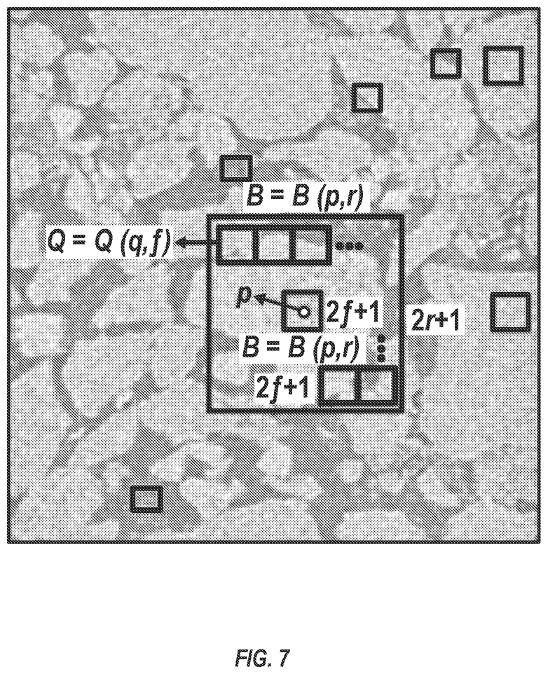

In some cases, the image processing platform includes pre-processing and filtering. FIG. 7 illustrates the fundamentals of non-local means filtering as a non-linear filtering method implemented in the image processing platform. The highlighting search window and template patch are illustrated. There are three key equations that govern this technique, as follows:

$${\hat{B}}_{ι} = \frac{1}{C} {\sum }_{Q = Q ( q , f ) ∈ B ( p , r )} {u}_{i} ( Q ) w ( B , Q ) , C = {\sum }_{Q = Q ( q , f ) ∈ B ( p , r )} w ( B , Q )$$

$${d}^{2} ( B ( p , f ) , B ( q , f ) ) = \frac{1}{3 {( 2 f = 1 )}^{2}} {\sum }_{i = 1}^{3} {\sum }_{j ∈ D ( 0 , f )} {( {u}_{i} ( p + j ) - {u}_{i} ( q + j ) )}^{2}$$

$$w ( B , ( p , f ) , B ( q , f ) ) = {e}^{- \frac{max ( {d}^{2} - 2 {σ}^{2} , 0. )}{{h}^{2}}}$$

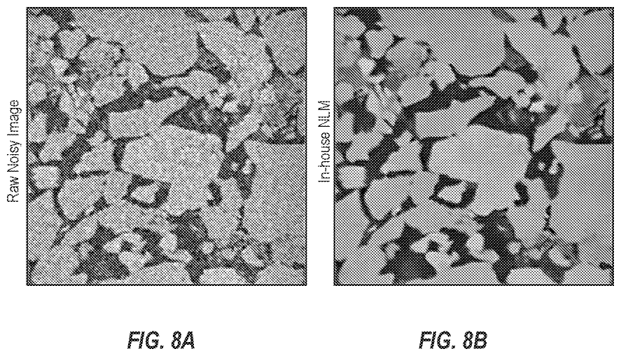

Here, B=B (p,r) is the search window neighborhood centered at pixel p with size (2r+1)2, B=B (p,f) is the template patch used to compute weights centered at p with size (2f+1)2, Q=Q (q,f) denotes neighboring template patches centered at pixel q with size (2f+1)2. Weight w depends on the squared Euclidean distance d² between each two patches. The parameter h is the filtering parameter. In this technique, each pixel value may be restored as an average of the most resembling pixels, based on the notion that noise is a random variable with zero mean. Noise removal at a pixel is not local to its neighborhood unlike other filters. Edge pixels are typically different from their surrounding pixels, so their w may be low and may not be averaged/smoothed out heavily. Here, a GPU-accelerated patch-wise implementation of non-local means may be performed by one or more GPUs. FIG. 8A shows an the raw noisy micro-CT image, while FIG. 8B shows a de-noised image using GPU-accelerated non-local means filtering implemented in the platform. The results may be obtained by applying the image processing platform to a raw noisy rock image with optimized parameters of r=11, f=3, h=5.

In some cases, the de-noising of images may be followed by contrast stretching and image intensity enhancement necessary for proper segmentation. The platform may be calibrated with certain intensity range. In some cases, the user may input information to facilitate contrast stretching is executed iteratively until the desired mean and standard deviation of intensity histogram, for which the platform is calibrated, are achieved. In some cases, the parameters used in the segmentation workflow may be further calibrated.

Following the above pre-processing and filtering steps, one or more CPUs and GPUs may implement a modular segmentation workflow. This workflow starts by adaptive local thresholding of the gray-scale image. This module is implemented such that it finds the local threshold T for a pixel by computing the mean m and standard deviation s of a window of radius R centered on the pixel following this equation:

$$T ( x , y ) = m ( x , y ) [ 1 + {pe}^{- qm 9 ( x , y )} + k ( \frac{s ( x , y )}{R} - 1 ]$$

Application of adaptive local thresholding may allow the image processing platform to effectively process low contrast images. It may also allow the image processing platform to be content-aware in a way it is sensitive to spatial variation of intensities within a search window, which helps to better preserve the fine features like connections and bridges that would otherwise be not detected by global thresholding. Adaptive local thresholding may be performed without significant user input (e.g., to specify any threshold manually).

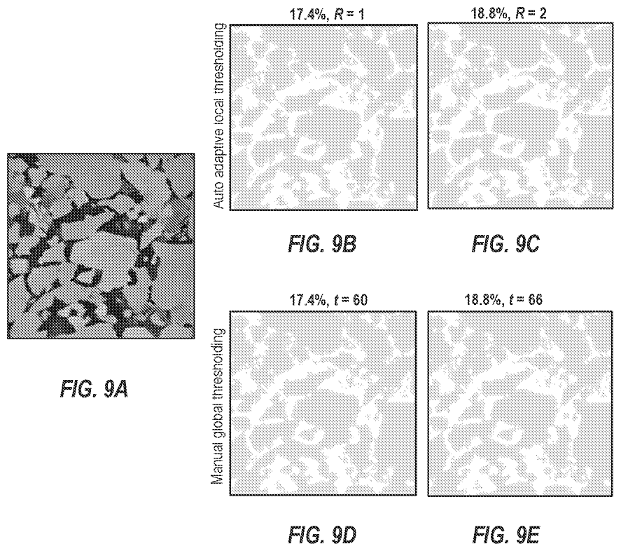

FIGS. 9A-9E illustrate a comparison between adaptive local thresholding and a standard manual thresholding that would result in a similar void fraction (i.e., porosity). Comparison between adaptive local thresholding with two search radii (R) may be implemented in the platform with manual global thresholding. For the latter, two different thresholds were selected such that similar void fractions are achieved. Results show the adaptive method better captures the connectivities. FIG. 9A shows the de-noised image using GPU-accelerated non-local means filtering implemented in the platform. FIG. 9B and FIG. 9C show the adaptive local thresholding. FIG. 9D and FIG. 9E show manual thresholding. The adaptive local thresholding better maintains local fine features of the source porous media sample than the manual thresholding and is more sensitive towards local contrast variations (e.g., between intermediate grays surrounded by dark grays that are associated with micro- and macro-pores, respectively).

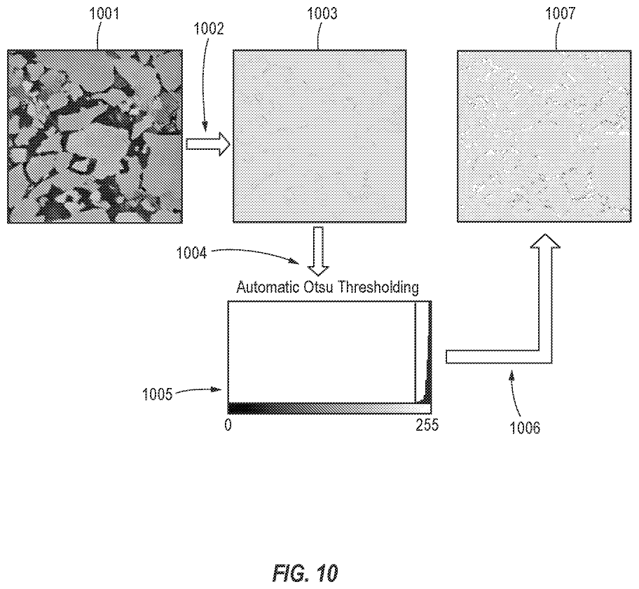

It is important to capture connectivities within pore space to facilitate effective DRT. To properly characterize connectivities within an imaged porous medium, the image processing platform may apply a top-hat transform filter on the raw gray-scale image via one or more GPUs. This technique subtracts the original image from the result of a morphological opening (e.g., erosion followed by dilation) which aims to enhance and isolate the dark structures of the image. The GPUs then apply an automatic Otsu thresholding to binarize the result of top-hat transformation. Otsu is an optimization-based segmentation technique that finds the optimal a threshold that minimizes intra-class intensity variance, or equivalently, maximizes inter-class variance. FIG. 10 depicts an example procedure for enhancing features of a porous media image. A workflow is applied to a raw filtered image of rock. At operation 1002, the image 1001 is top-hat transform filtered to form image 1003. At operation 1004, an automatic Otsu thresholding segmentation is performed to form the histogram 1005. At operation 1006, the workflow 1000 enhances and isolates the dark features like connectivities and corners as shown in image 1007.

As illustrated in FIG. 9, the adaptive local thresholding naturally results in an unsmooth segmentation where small holes can arise in the segmented region. Therefore, the image processing platform implements the following series of morphological operations.

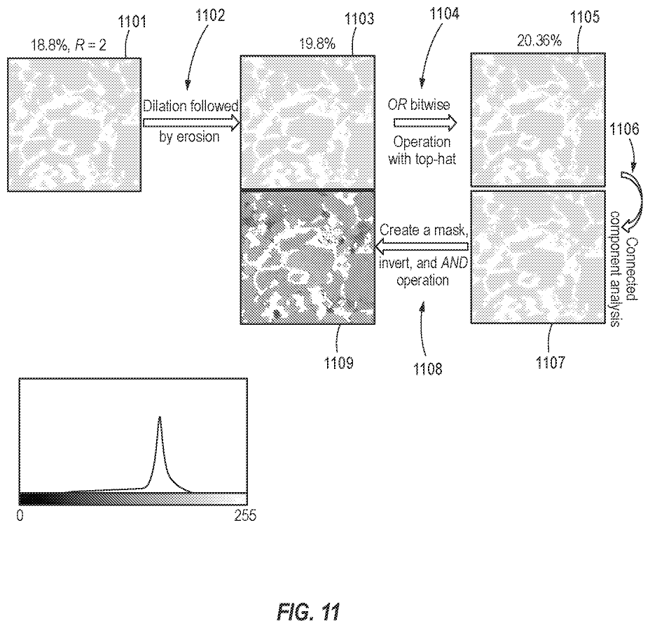

FIG. 11 illustrates an automated workflow process. The automated workflow process entails a series of morphological image processing operations applied to the segmented image from adaptive local thresholding. At operation 1102, the image 1101 is dilated and eroded to form image 1103. At operation 1104, the image 1103 is subjected to the OR bitwise operation with the top-hat transform filter to form image 1105. At operation 1106, the image 1105 is subjected to connected component analysis to form image 1107. At operation 1108, the image 1107 is used to create a mask, inverted, and the AND bitwise operation is performed to form image 1109. The automated workflow process 1100 results in a mask of the raw gray-scale image where the macro-pores detected so far are blacked out with zero intensity, as shown in the histogram 111.

Dilation of a binary image may add pixels to the edges of objects in a binary image, while erosion removes pixels from the edges of objects. The sequence may result in smoothing of boundaries and filling the holes of the internal areas of the segmented region without inflating the rest of the segment. The result is then superimposed with a binary result of the top-hat transform on the gray-scale image using a bitwise OR operation. This step may be followed by applying a connected component labeling analysis whereby any small disconnected region below a certain width (due to noise or pixelated nature of digital image) may be removed from the image. Finally, following inversion and an AND bitwise operation, a mask of the original image is created. This may lead to a new histogram where all the pores are zeroed out and there remains only one mode pertaining to grains.

Motivated by the micro-porosity estimation, the image processing platform may consider multi-class segmentation of the masked image. One or more GPUs may implement K-means clustering. K-means clustering is an unsupervised machine learning technique that trains a model based on a given dataset to learn the relation between each datapoint and a cluster centroid. At its core, the technique minimizes within-cluster variances (e.g., squared Euclidean distances). Given an initial set of k means, the technique proceeds by alternating between two steps: An assignment step which assigns each pixel value to the cluster with the nearest mean (e.g., with the least squared Euclidean distance), followed by an update step whereby the means or cluster centroids for the new clusters are recalculated. The technique converges when the assignments no longer change.

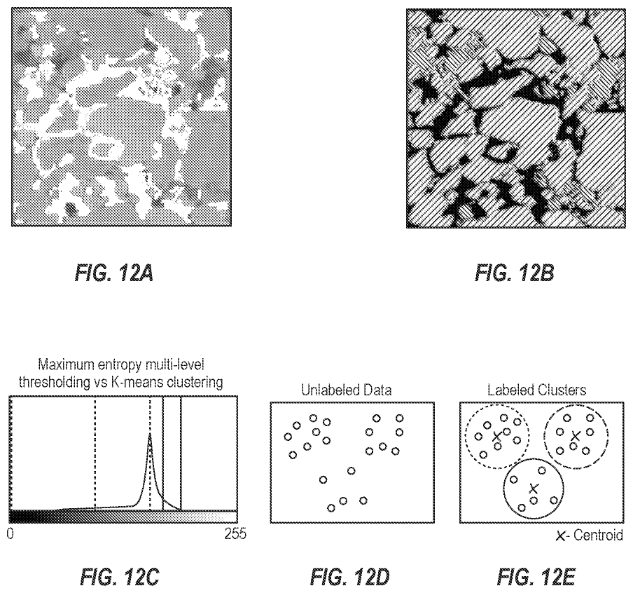

An example of k-means clustering with k=3 is shown with respect to FIGS. 12A-12E. The k-means clustering forms FIG. 12B from FIG. 12A. The intensity values of the obtained centroids that represent 3 clusters are sketched in FIG. 12D and FIG. 12E. The 3 clusters are shown grouped in FIG. 12E. One cluster correctly represents the masked (macro-pore) region, while one cluster has the highest centroid value equal to grain mode. The intermediate cluster has a centroid value that correctly falls between 0 (masked macro-pores) and grain mode. The cluster each pixel belongs to arises from applying the trained model to predict the clusters for the unseen pixels given their Euclidean distance from centroids. This is more robust than threshold-based methods where the classes are solely determined by whether pixel intensity values are below or above each threshold. For comparison, the thresholds found by the maximum entropy multi-level thresholding method is illustrated in FIG. 12C, which shows this technique is unable to distinguish the classes correctly since the two thresholds are both found to be larger than grain mode.

Once the clusters are determined for each image slice, a series of morphological operations may be performed by one or more processor on the extracted intermediate phase to eliminate the partial volume effect explained previously. To this end, the processor may measure the internal gradient of the binary image from the previous step that consists of the intermediate phase with micro-pores as well as the artificial phase boundary layers. The internal gradient automatically reveals the boundaries of the structures within the image. Subtracting the result from the extracted intermediate phase eliminates the boundary layers. This is followed by a dilation process to recover other regions that were eroded.

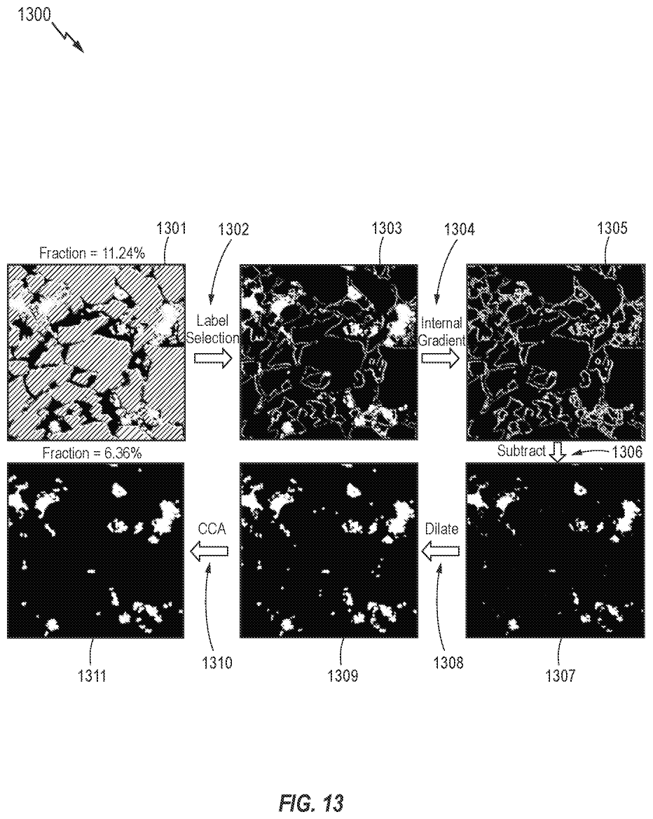

Finally, connected component analysis is performed by the processors to remove the small isolated regions. This workflow brings the total fraction of intermediate phase from 11.24% down to 6.36%. FIG. 13 depicts an example workflow to refine an extracted phase from a trinary image. The automated workflow 1300 morphologically “cleans” the intermediate phase extracted from the trinary image that resulted from k-means clustering. At operation 1302, the image 1301 is subjected to label selection to form image 1303. At operation 1304, an internal gradient is measured to form image 1305 from image 1303. At operation 1306, the internal gradient is subtracted from the image 1305 to form image 1307. At operation 1308, the image 1307 is dilated to form image 1309. At operation 1310, the image 1309 is subjected to connected component analysis to form image 1311.

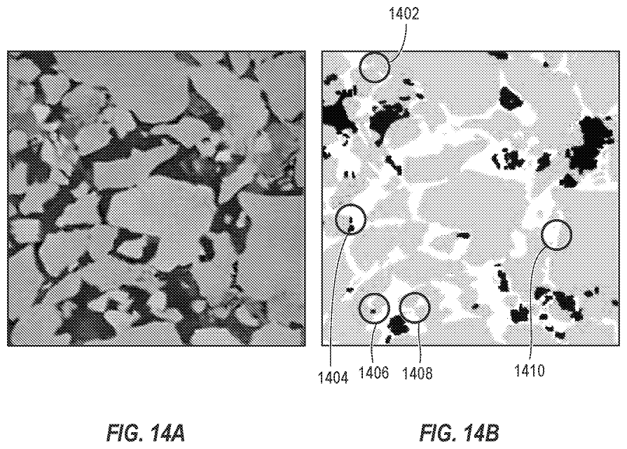

FIG. 14A shows the gray-scale de-noised image. FIG. 14B shows the stitched de-noised image. At this stage, the final intermediate phase label can be stitched with the macro-pores used to mask the gray-scale image to compose the trinary segmentation result. However, it can be seen (denoted by circles 1402, 1404, 1406, 1408, 1410) that while this workflow is relatively robust and advantaged by automation, it still cannot fully capture the continuity within each phase and the connectivities between neighboring pore bodies.

After clusters are determined for each slice, classical watershed segmentation may be performed by one or more CPUs based on the principle that any grey-tone image may be considered as a topographic surface, where a water source is placed in each regional minimum. The entire relief may be flooded from the sources, and dams (or watershed lines) may be placed where the different water sources meet. In practice, this transform produces an important over-segmentation due to noise or local irregularities in the gradient image.

Aspects of the present disclosure provide a marker-controlled watershed method that represents an enhancement of the classical watershed transformation. Specifically, the topographic surface is flooded from a previously defined set of markers, which helps to reduce over-segmentation. According to certain aspects, the one or more CPUs apply this marker-controlled variant of watershed transformation that incorporates compact superpixel segmentation based on watershed. In conventional marker-controlled watershed segmentation, the seeds grow iteratively pixel by pixel until they reach a border to the segment around another seed. These borders form the watersheds. The next seed may expand by one pixel and may be chosen based on a distance function. This distance function may incorporate the intensity value of the pixels. This results in strongly varying borders in homogeneous image regions and potentially highly irregularly shaped segments in the presence of image gradients.

In the new adaption of this watershed technique, the distance to the seed point is incorporated. The resulting distance metric is the weighted combination of the conventional intensity-based distance and the Euclidean distance of the pixel to the segment seed. A compactness (C) parameter constraints the seed growth, favoring seeds that are close to the pixel being considered. Therefore, it results in a constraint on the size and elongation of the segments and thus favors the creation of compact segments. Accordingly, techniques described herein may utilize non-binary markers that are externally generated, and may allow flooding in fully diagonal directions (e.g., 8-connectivity in 2D and 26-connectivity in 3D).

To implement the marker-controlled watershed segmentation, the one or more processors implement a workflow to generate the sets of markers for the marker-controlled compact watershed segmentation. Generating markers may produce three definite segments for macro-pores, micro-pores, and grains (regions). These regions combined compose a part of the original image, with the rest of the image marked as unknown. The marker-controlled watershed segmentation may determine the label for the unknown portions of the image.

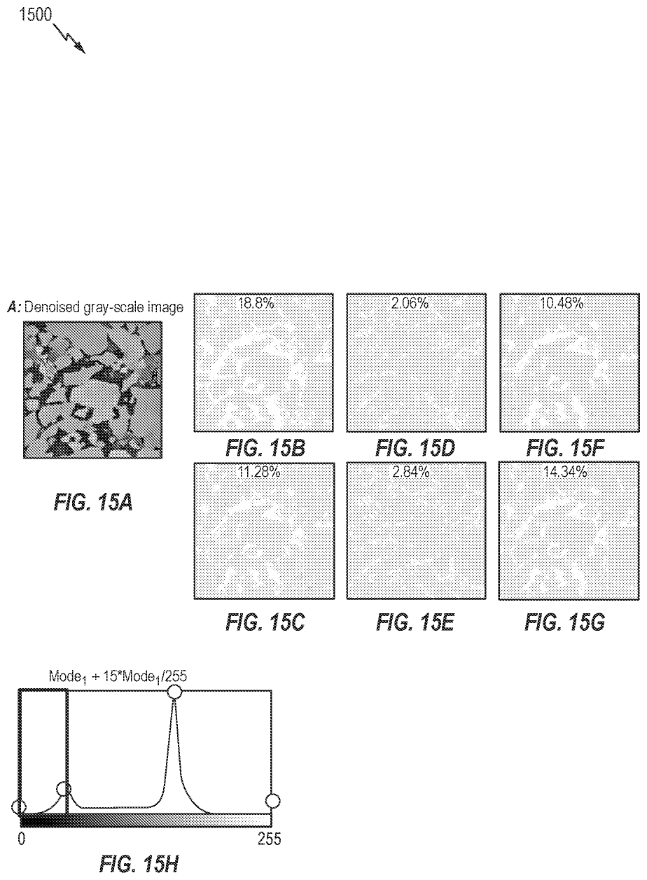

FIGS. 15A-15H illustrate the implemented steps to obtain markers for sure macro-pore region. FIG. 15A shows the de-noised gray-scale image. FIG. 15B shows a binary image subjected to adaptive local thresholding. FIG. 15C shows a binary image subjected to conservative global thresholding. Adaptive local thresholding may be first performed via one or more CPUs on the de-noised gray-scale image (FIG. 15A), resulting in the binary image of FIG. 15B. At the same time, a conservative global thresholding is performed on this raw image. The one or more CPUs performs a global search in the histogram of the pixel intensities and finds the dominant mode frequency of macro-pores and grain. The implemented algorithm is robust to various degrees of noise in the histogram shown in FIG. 15H. On an 8-bit gray-scale image, the aforementioned conservative global thresholding sets the threshold according to the following equation:

$${T}_{pore} = {Mode}_{pore} + \frac{{X}_{pore}}{255} * {Mode}_{pore}$$

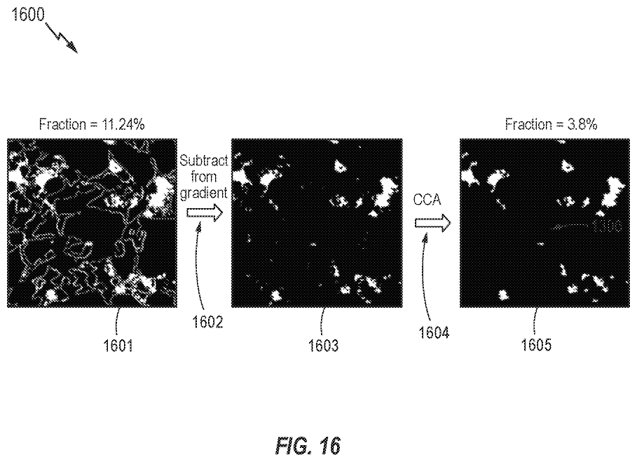

The Xₚₒᵣₑ may have a default value of 15, but may be changed. This step results in FIG. 15C. Next, a top-hat transform is applied to FIG. 15B and FIG. 15C, followed by automatic Otsu binary segmentation, resulting in FIG. 15D and FIG. 15E, respectively. To ensure the definiteness of macro-pore markers, morphological erosion with a radius of one is then applied to FIG. 15D and FIG. 15E, resulting in FIG. 15F. A series of bitwise OR operations will sequentially be applied to FIG. 15F to compose a compound image, followed by connected component analysis to eliminate small isolated regions, which ultimately leads to the macro-pore marker for the given image slice as shown in FIG. 15G. Markers for the intermediate phase may be generated from first performing steps described above, which may include obtaining a first estimate of macro-pores (e.g., using adaptive local thresholding, top-hat transform, dilation, erosion, connected component labeling, masking) followed by k-means clustering of the resulting masked image. FIG. 16 depicts example definite regions for the intermediate phase. Using workflow 1600, at operation 1602, the binary image for the intermediate phase that is extracted from the trinary clustered image (e.g., image 1601) is subtracted from its internal gradient to form image 1603. At operation 1604, the one or more CPUs performing connected component analysis to form image 1605. The final result may be definite regions for the intermediate phase.

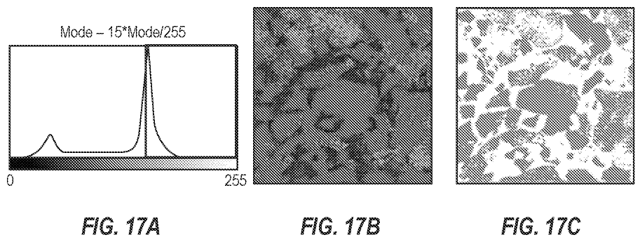

FIG. 17A illustrates a histogram of an 8-bit gray scale image. FIG. 17B illustrates the grain portion (light gray) of the 8-bit gray scale image. FIG. 17C illustrates the pore portion (white) of the 8-bit gray scale image. For grain markers, a conservative global thresholding may be performed on the original raw image. On a 8-bit gray-scale image, the threshold may be set according to the following equation:

$${T}_{grain} = {Mode}_{grain} - \frac{{X}_{grain}}{255} * {Mode}_{grain}$$

The X_{grain} has a default value of 15 but is free to be changed by the user. With the three sets of markers generated, phase relabeling and stitching with the remaining unknown regions may be performed to construct the input for the marker-controlled watershed.

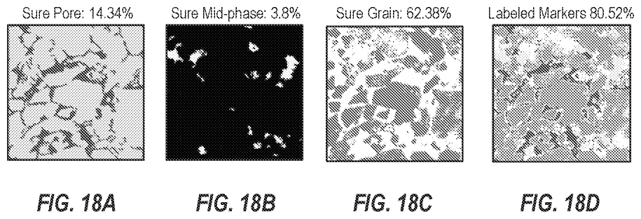

FIG. 18A illustrates a pore portion of the 8-bit gray scale image. FIG. 18B illustrates mid-phase portion of the 8-bit gray scale image. FIG. 18C illustrates grain portion of the 8-bit gray scale image. FIG. 18D illustrates composite image of the pore portion, mid-phase portion, and grain portion of the 8-bit gray scale image. In FIG. 18D 19.48% of the image is yet to be classified by the final step.

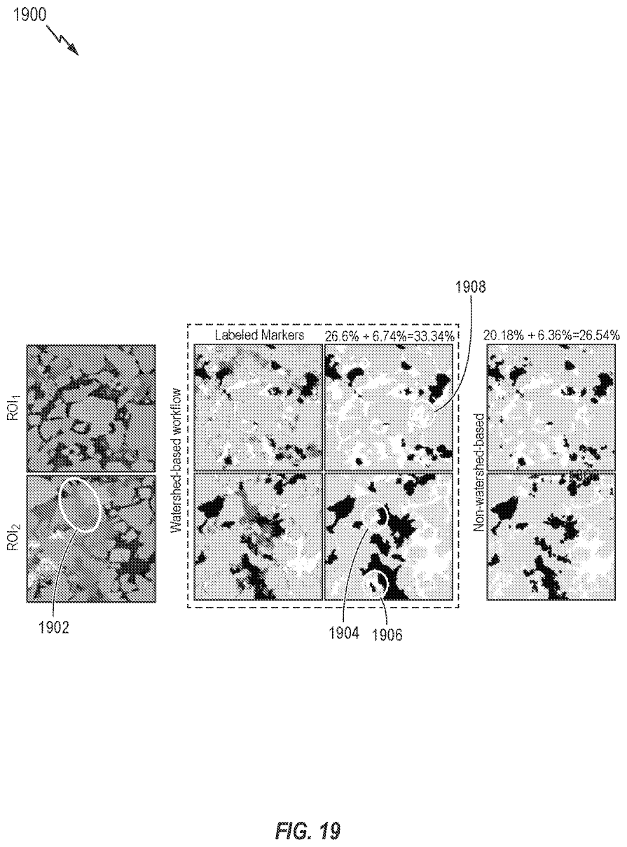

FIG. 19A illustrates the 8-bit grayscale image. FIG. 19B illustrates a watershed-based workflow. FIG. 19C illustrates a non-watershed-based workflow. The watershed-based workflow shows the initial result for watershed-based segmentation without compactness compared to non-watershed-based segmentation from previous steps. In some cases, the final step includes one or more processors performing the marker-controlled watershed. This step involves the one or more processors obtaining the original gray-scale image and the four-label image containing the constructed markers with 0 representing the unknown regions. Two regions of interest (ROIs) are highlighted in addition to the labeled markers. The results show significant improvement over the non-watershed-based counterparts because the continuity of within-phase pixels are very well recovered.

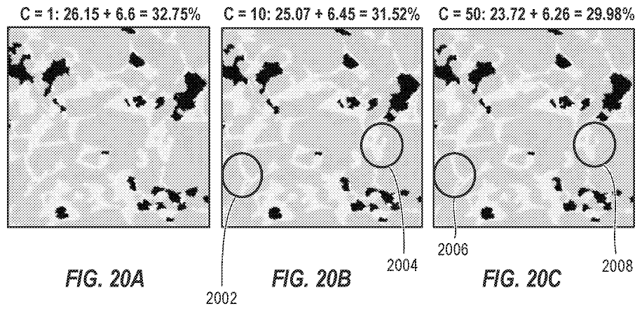

FIG. 20A illustrates a watershed-based workflow with a compactness level of 1. FIG. 20B is illustrates a watershed-based workflow with a compactness level of 10. FIG. 20C illustrates a watershed-based workflow with a compactness level of 50. Increasing the compactness resolves the over-segmentation issue by constraining the seed growth resulting of a plurality of pores, such as first pore 2002, second pore 2004, third pore 2006, and fourth pore 2008. In some cases, issues may still exist after the execution of this step. For example, the region-based watershed method may over-segment the macro-pore region and under-segment the intermediate phase. These issues may be addressed using certain optimization operations. The image processing platform may facilitate the optimization of the segmentation through parameters that determine the markers such as search radius of adaptive local thresholding, erosion level, Xₚₒᵣₑ and X_{grain}, as well as the compactness level of the watershed technique.

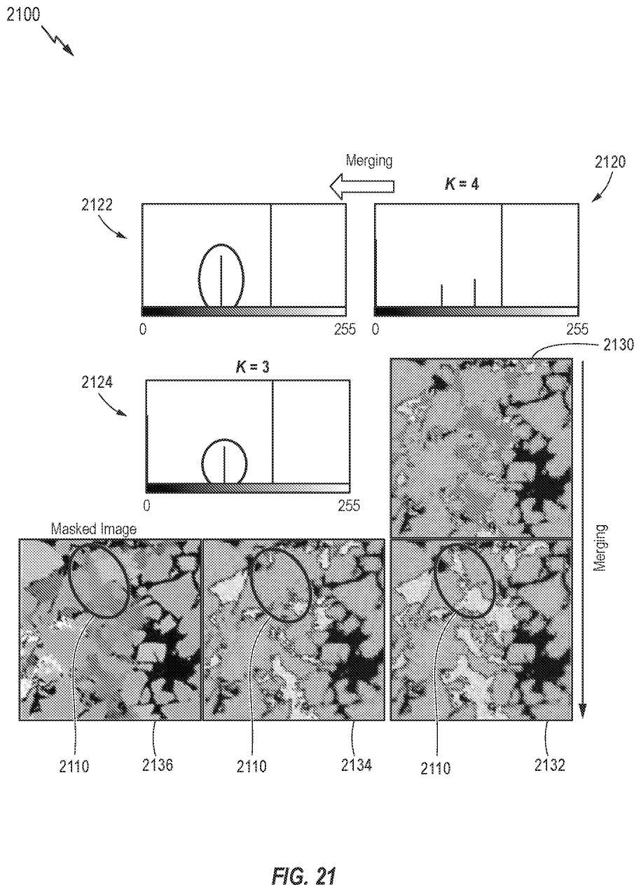

FIG. 21 illustrates the effects of k-means clustering. In some cases, to circumvent under-segmentation of the intermediate phase, the image processing platform may facilitate higher-dimensional clustering and subsequent merging of clusters to construct the trinary segmentation image. This step captures the multi-component nature of porous media in a refined manner such that a subsequent merger between the intermediate clusters may lead to a more accurate representation of the middle phase that contains micro-pores. An example comparison between k=3 and k=4 is illustrated in a first graph 2120, a second graph 2122, and a third graph 2124. The first graph 2120 shows the histogram the 8-bit grayscale image after the k-means clustering with a k=4, where k is the number of clusters. The third graph 2124 shows the histogram after the k-means clustering with a k=3. The second graph 2122 shows the histogram after a merge of the intermediate phases. A fraction of intermediate phase is larger, both qualitatively and quantitatively, for the case of higher-dimensional clustering. A first micrograph 2130 illustrates the 8-bit grayscale image after k=4 clustering, corresponding to the first graph 2120. A second micrograph 2132 illustrate the 8-bit grayscale image after merging the intermediate phases of the first micrograph 2130. A fourth micrograph 2136 illustrates the 8-bit grayscale image after k=4 clustering, corresponding to the first graph 2124. A third micrograph 2134 illustrate the 8-bit grayscale image after merging the intermediate phases of the fourth micrograph 2136. A pore 2110 is illustrated in each of the micrographs 2132, 2134, and 2136.

In some cases, challenges arise when opting for such higher-dimensional clustering. For example, clustering may become more computationally expensive. Random initialization of centroids may be more prone to yield results that are not converged and not consistent slice to slice. In higher-dimensional clustering, an optimal k may be found.

In some cases, AI training within the image processing platform may be performed on a fraction of data, which may be obtained, for example, from converting the two-dimensional images converted into one-dimensional vectors, followed by prediction based on the trained model. This AI training and inference may be performed one or more GPUs. The image processing platform may utilize a fast and stable scalable kmeans++ initialization method that may ensure the k initial cluster centers are as spread out as possible. This may increase the chances of initially picking up centroids that lie in different clusters. Further, a large oversampling factor may be utilized to increase the amount of points to sample in scalable k-means++ initialization for potential centroids. Increasing this value can lead to better initial centroids at the cost of memory.

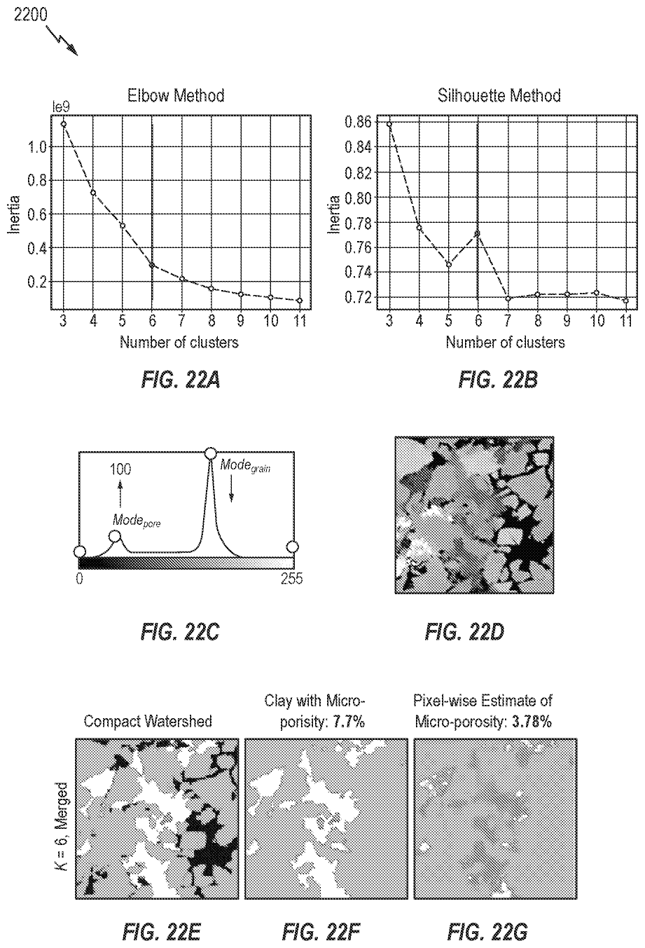

FIG. 22C illustrates a histogram of the 8-bit grayscale image, while FIG. 22D illustrates the 8-bit grayscale image. To obtain the optimal k, one or more processors may compute an inertia score that is the sum of the squared distance between each data point and its centroid across clusters. The one or more processors may implement the elbow method (FIG. 22A) to determine the optimal k above which the decrease in inertia due to increase in k is not substantial. Additionally, the Silhouette score (FIG. 22B) defined as (b−a)/max(a, b), with b the mean nearest-cluster distance and a the mean intra-cluster distance is also provided by the one or more processors. A k above which the Silhouette score shows a sharp drop is equivalently considered as optimal. As shown in FIG. 22E-22G, the one or more processors may find k=6 is the optimal number for typical sandstone reservoir samples. The k-means clustering enables a determination of the porosity of the intermediate phases, e.g., the clay.

With the intermediate phase accurately segmented, the last component of the segmentation workflow is micro-porosity inference, which may result from the identification of a cluster of grains (e.g., like clay material that contains micro-pores). As discussed above, this phase consists of mixed pixels that contain grains and under-resolved pores and as such not 100% of this phase amounts to micro-porosity. For this reason, the image processing platform may include an interpolation scheme between the previously identified Modeₚₒᵣₑ and Mode_{grain} as two end-points with Modeₚₒᵣₑ associated with 100% micro-porosity and the Mode_{grain} associated with 0% micro-porosity, and any intensity in between is mapped to a corresponding micro-porosity according to the following equation:

$${p}^{*} = \frac{100}{{Mode}_{pore} - {Mode}_{grain}} ( p - {Mode}_{grain} )$$

Parameter, p, is the gray-scale intensity of a pixel within the segmented intermediate phase and p* the interpolated pixel value between 0 and 100. Due to the high computational load linked with this pixel-wise calculation, this module may be implemented on one or more GPUs. Following this proposed approach, the micro-porosity in of the intermediate phases, e.g., clay, is inferred as 3.78%, which translates to a ~0.49 mean micro-porosity fraction that should be assigned on average to the clay content (i.e., every pixels within the intermediate phase). This micro-porosity estimate may be added with previously estimated macro-porosity, leading to 27.4% total porosity, which is in agreement with the experimental measurements obtained for the same rock sample in the laboratory. This agreement validates the workflow with respect to experiments.

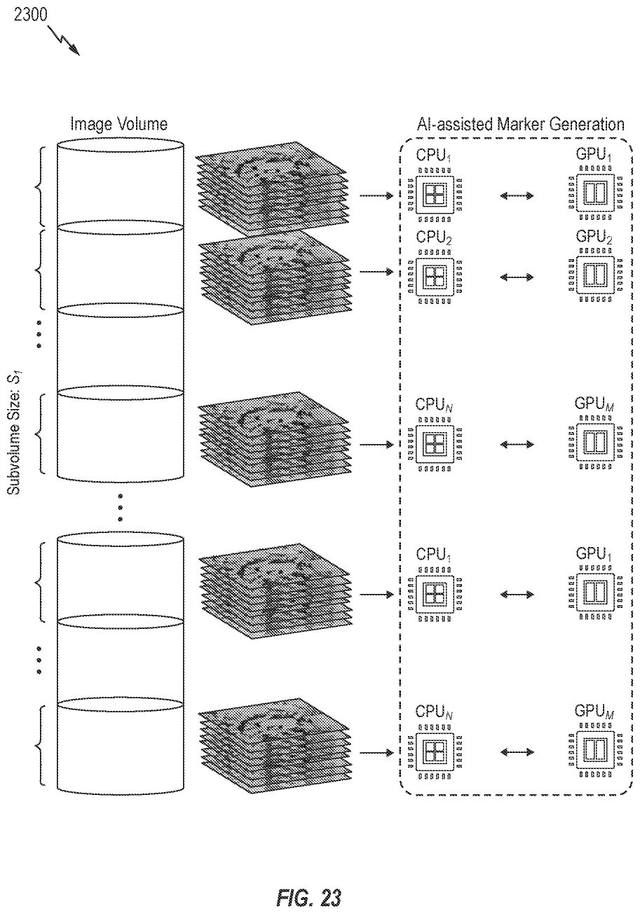

In some cases, processing high-resolution micro-CT images of rocks may be computationally expensive, especially for larger porous media samples. Aspects of the present disclosure provide significant computational speedup and efficient and reliable performance by massively parallelizing actions performed by one or more processors. The parallel processing paradigm implemented herein may be categorized into two groups. The first group includes parallelization for features, which may assist in processing AI-assisted marker generation. FIG. 23 illustrates a schematic of a parallel processing workflow 2300. The 3D image volume is decomposed into multiple non-overlapping subvolumes with size S1. The number of subvolumes N_{batch,1} for this stage is determined as follows:

$${N}_{batch , 1} = \frac{{N}_{t} + {S}_{1} - 1}{{S}_{1}}$$

Nₜ is the total number of 2D image slices in the volume stack. N_{batch,1} may be equivalent to the total number of jobs that need to be executed to process the whole image volume. Aspects of the present disclosure may execute a user-defined number of jobs in parallel, denoted by Nₚₐᵣₐₗₗₑₗ. This parameter may be defaulted to the total number of available processor threads but may be set to a lower value for better optimization and strike a balance between processor usage to system memory (e.g., random access memory (RAM)) consumption. If N_{batch,1} is greater than the total Nₚₐᵣₐₗₗₑₗ, Nₚₐᵣₐₗₗₑₗ number of parallel jobs may be executed on corresponding threads. Once each thread completes its execution, the processors proceed to execute another batch (i.e., process another subvolume) in the queue. This cycle may continue until all batches are processed. Furthermore, the optimal value of S₁ may be empirically obtained by considering the available system memory (e.g., RAM), file size of each image slice, and Nₚₐᵣₐₗₗₑₗ. The processors checks the following relation:

$$slice filesize \times {S}_{1} \times {N}_{parallel} < 0.5 \times system memory .$$

The processors may then output a warning for possible memory oversubscription if the above relation is not true.

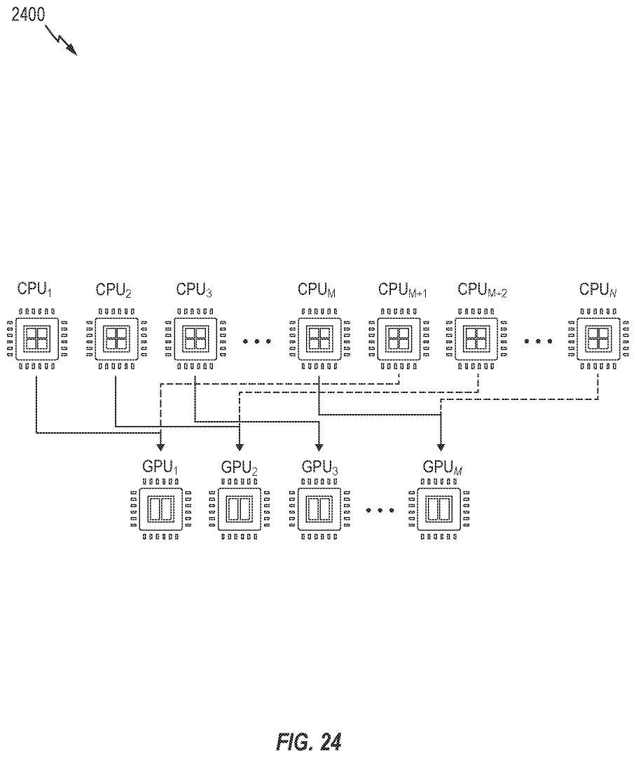

While Nₚₐᵣₐₗₗₑₗ batches are executed in parallel, the S₁ image slices within each subvolume may be processed serially in time and may be managed by one assigned processor in concert with at least one GPU as a co-processor. A heterogeneous computer node may typically possess M GPU device accelerators (e.g., co-processers) and N CPU host processors. Without loss of generality, it may be assumed the M<N. In some cases, N may be replaced by Nₚₐᵣₐₗₗₑₗ if Nₚₐᵣₐₗₗₑₗ<N. For an unequal number of CPUs and GPUs, a mapping between CPU and GPU processors take place internally, as shown in FIG. 24. FIG. 24 is a hierarchical hardware mapping 2400 between CPUs and GPUs adopted for heterogeneous compute nodes, according to aspects of the present disclosure. The processors may offload the computationally intensive tasks as described above on to the available GPUs to massively accelerate the execution, followed by data transfer back to CPU host. When there are less available GPU devices than the invoked CPU threads, the extra CPU threads may bind with the previously subscribed GPU devices in a cyclic fashion. Based on this hierarchical mapping, the platform may also output a GPU oversubscription warning if the following relation is false Nₚₐᵣₐₗₗₑₗ:

$$slice filesize \times \frac{{N}_{parallel}}{M} < 0.5 \times GPU memory$$

Once markers are generated, the processors perform 3D marker-controlled compact watershed segmentation. The processors then perform 3D segmentation to capture the continuity of the underlying 3D microstructure of porous media (e.g., a rock sample).

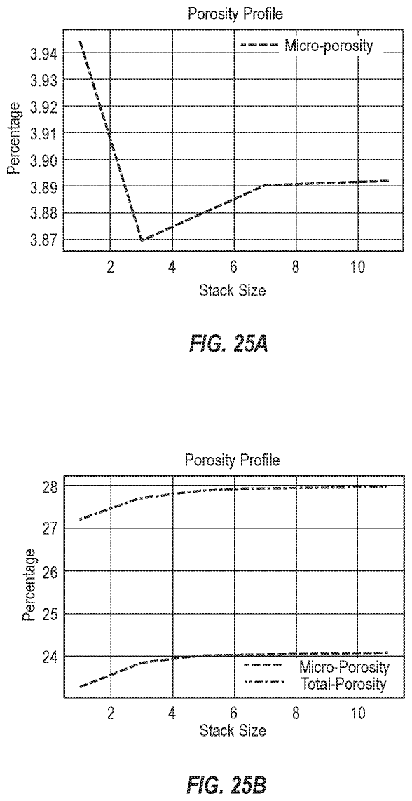

To enable the above parallelization, the processors implement a threshold for an optimal stack size used to find a robust 3D segmentation result for a mid-slice. The processors perform a stand-alone analysis to find this threshold size. FIGS. 25A and 25B illustrates a stand-alone evaluation of the impact of stack size on the 3D watershed-based segmentation with respect to the mid-plane slice within the stack. FIG. 25A illustrates the micro porosity based on the stack size. FIG. 25B is the macro porosity and the total porosity based on stack size. In one embodiment, a mid-slice is sandwiched between a growing number of slices that compose an image subvolume stack. This sensitivity analysis finds an optimal, threshold stack size above which any increment in the size of stack does not affect the results and hence may be avoided due to the exponential growth of computational time and memory in 3D segmentation. The micro-, macro-, and total porosities for the midplane may be calculated following 3D segmentation applied step-wise to each 3D subvolume. As illustrated, the macroscopic porosity properties that are analyzed reach a plateau after a certain representative size. This is because all the necessary 3D information surrounding the target plane may reach the plane above this volume size during the 3D watershed segmentation. In some cases, padding size Sₚ may be defined as follows:

$${S}_{p} = ( {S}_{1}^{*} - 1 ) / 2 ,$$

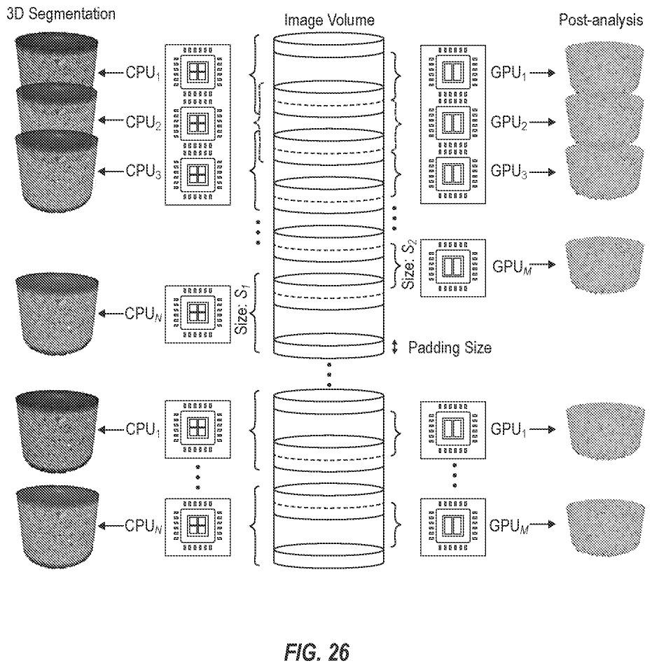

Here, S₁* may be defined as a threshold subvolume size at which the 3D segmentation converges with respect to the stack size. The processors may take the Sₚ value as an input and decomposes the 3D image volume into N_{batch,2} partially overlapping subvolumes of size S₁ with an overlap region of size 2Sₚ, as outlined in FIG. 26. Hence, the number of batches may be defined as follows:

$${N}_{batch , 2} = \frac{{N}_{t} + {S}_{2} - 1}{{S}_{2}} ,$$

$${S}_{2} = {S}_{1} - 2 {S}_{p} ,$$

This may result in a greater number of batches to be processed as compared with N_{batch,1}. Each batch is then processed to perform a 3D segmentation on the corresponding 3D subvolume of size S₁ using a single processor. Similar to previous steps within the platform, Nₚₐᵣₐₗₗₑₗ segmentation jobs may be conducted in parallel on Nₚₐᵣₐₗₗₑₗ number of processing threads. Another factor may determine the optimal magnitude of S₁ to be the computational runtime associated with executing each 3D segmentation. The computational runtime as well as system memory consumption tend to exponentially grow for exceedingly larger stack sizes S₁.

Once the trinary labelled image stacks are obtained for each batch, the central sub-stack of size S₂=S₁−2Sₚ may be extracted from each overlapping stack and sent to a final, post-analysis step. The first and last Sₚ slices from each sub-stack may be expected to be affected by end effects arising from the lack of convergence in 3D segmentation.

A series of pixel-wise operations may be executed on each segmented image slice that exists in the extracted sub-stacks. These procedures may be accelerated on GPUs, and lead to accurate image-informed estimation of macro-porosity, intermediate mineral phase that contain micro-pores, as well as the micro-porosity. The platform follows the mapping between CPUs and GPUs outlined in FIG. 24 to offload the tasks to GPUs and receive back the results. The quantitative results from each batch are then written to a unique spreadsheet file and concatenated into one unified database at the end.

The parallel workflow described above may significantly reduce the runtime from a span of multiple days to a fraction of hour for a typical high-resolution image stack that consists of 2,000 image slices with each composed of 3000 by 3000 pixels. Domain decomposition that may be performed within the platform may not deteriorate the integrity of the results and takes full advantage of the hardware architecture of the compute node.

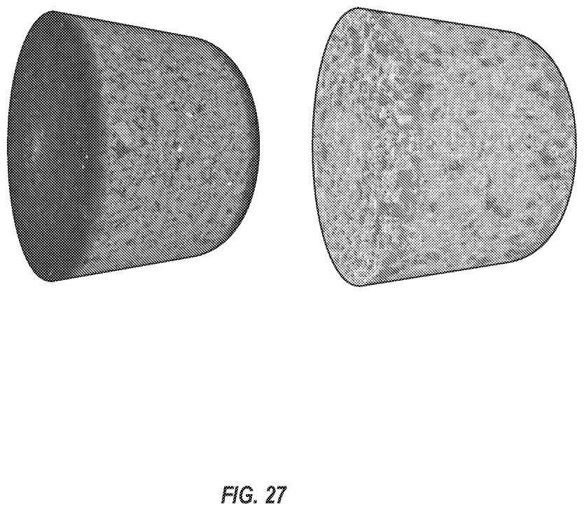

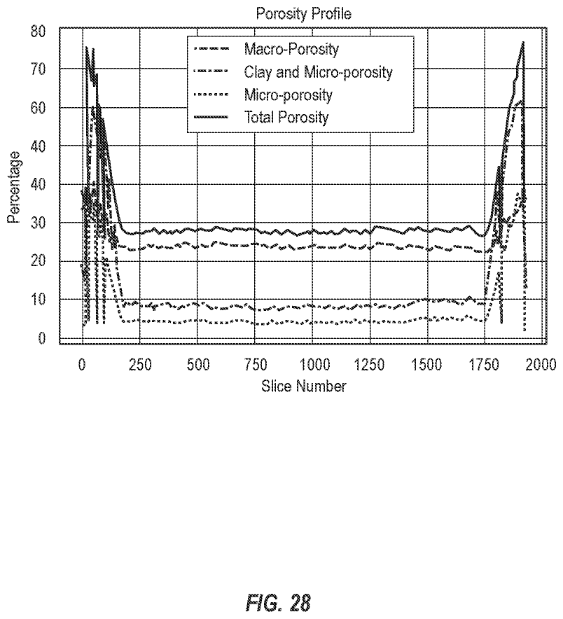

The example shown in FIG. 27 illustrates the quantitative results from deploying features described herein on the micro-CT images acquired from a sandstone reservoir core sample. In some cases, the one or more processors generate the profiles of petrophysical properties along the length of the core. FIG. 28 illustrates a porosity profile that captures the uniformity in the measured quantities along the core, which is an indication of not only the macroscopic homogeneity of the porous media sample but also the integrity and consistency of the workflow across the scanned volume.

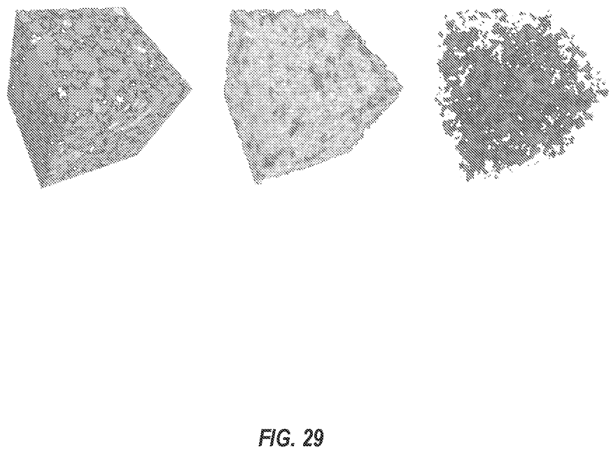

FIG. 29 provides a more detailed image at a 10003 voxel-size subvolume, illustrating the preprocessed and filtered volume as well as the trinary image result from the 3D segmentation and the extracted intermediate phase with the micro-porosity. Specifically, FIG. 29 shows a close-up visualization of de-noised image volume (left), three-class segmentation (middle), and extracted intermediate phase (right).

### Example Methods

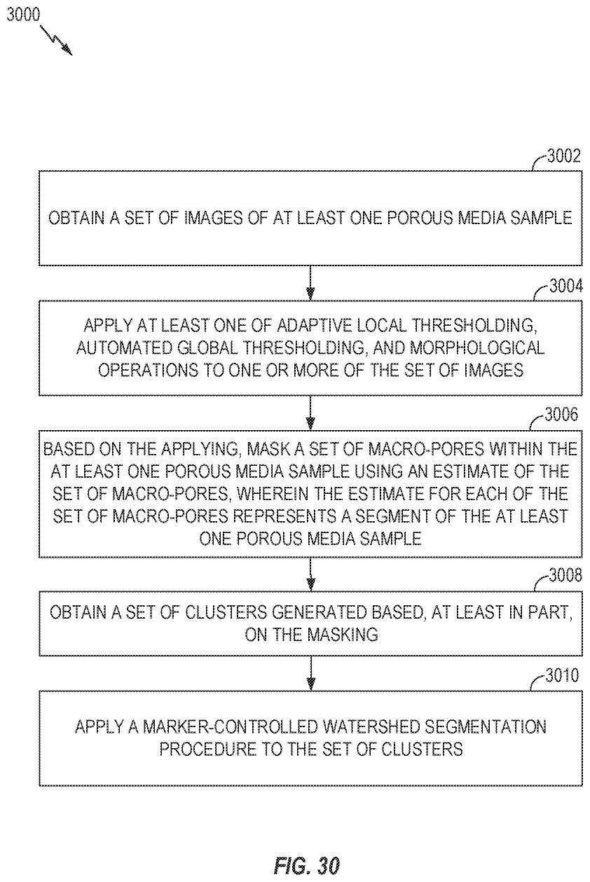

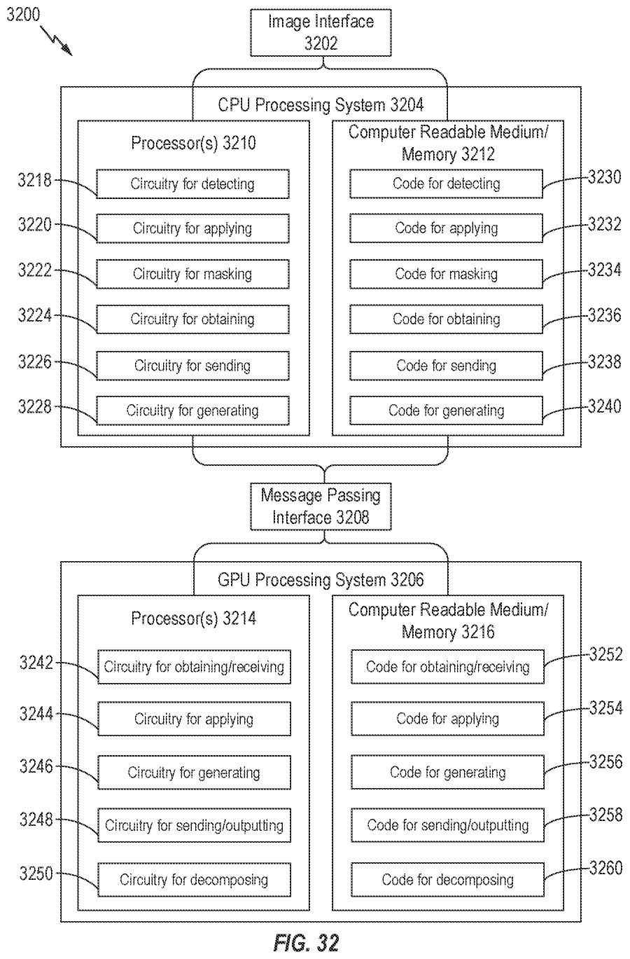

FIG. 30 depicts a method 3000 for processing images of porous media by one or more CPUs, such as the CPUs of the device 3200 of FIG. 32.

Method 3000 begins at 3002 with one or more CPUs obtaining a set of images of at least one porous media sample.

Method 3000 continues to step 3004 with one or more CPUs applying at least one of adaptive local thresholding, automated global thresholding, and morphological operations to one or more of the set of images.

Method 3000 continues to step 3006 with one or more CPUs based on the applying, masking a set of macro-pores within the at least one porous media sample using an estimate of the set of macro-pores, wherein the estimate for each of the set of macro-pores represents a segment of the at least one porous media sample.

Method 3000 continues to step 3008 with one or more CPUs obtaining a set of clusters generated based, at least in part, on the masking.

Method 3000 continues to step 3010 with one or more CPUs applying a marker-controlled watershed segmentation procedure to the set of clusters.

In one aspect, method 3000, or any aspect related to it, may be performed by an apparatus, such as imaging device 3200 of FIG. 32, which includes various components operable, configured, or adapted to perform the method 3000. Device 3200 is described below in further detail.

Note that FIG. 30 is just one example of a method, and other methods including fewer, additional, or alternative steps are possible consistent with this disclosure.

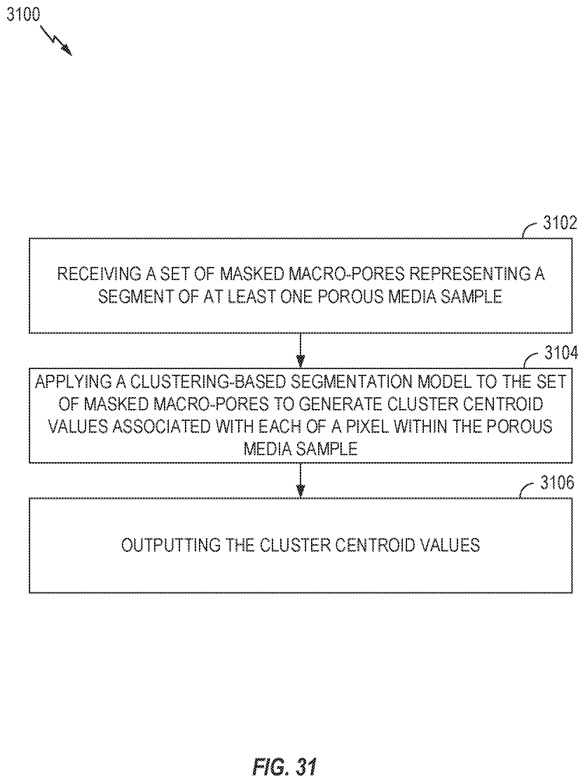

FIG. 31 depicts a method 3100 for multiscale imaging of porous media by one or more GPUs, such as the GPUs of the device 3200 of FIG. 32.

Method 3100 begins at 3102 with one or more GPUs receiving a set of masked macro-pores representing a segment of at least one porous media sample.

Method 3100 continues to step 3104 with one or more GPUs applying a clustering-based segmentation model to the set of masked macro-pores to generate cluster centroid values associated with each of a pixel within the porous media sample.

Method 3100 continues to step 3106 with one or more GPUs outputting the cluster centroid values.

In one aspect, method 3100, or any aspect related to it, may be performed by an apparatus, such as imaging device 3200 of FIG. 32, which includes various components operable, configured, or adapted to perform the method 3100. Device 3200 is described below in further detail.

Note that FIG. 31 is just one example of a method, and other methods including fewer, additional, or alternative steps are possible consistent with this disclosure.

### Example Device

FIG. 32 depicts aspects of an example porous media device 3200. In some aspect, the device 3200 comprises one or more CPUs, one or more GPUs, or both as described above with respect to FIGS. 30-31.

The device 3200 includes a CPU processing system 3204 coupled to an image interface 3202 (e.g., a user interface or and/or an image generator such as a commercial micro-CT scanner). The CPU processing system 3204 may be configured to perform processing functions for the device 3200, including multiscale imaging of porous media generated by the device 3200.

The CPU processing system 3204 includes one or more processors 3210. The one or more processors 3210 are coupled to a computer-readable medium/memory 3212 via a bus. The one or more processors 3210 and the computer-readable medium/memory 3212 may communicate with the one or more processor 3214 and the computer-readable medium/memory 3216 of the GPU processing system 3206 via a message passing interface (MPI) 3208. In certain aspects, the computer-readable medium/memory 3212 is configured to store instructions (e.g., computer-executable code) that when executed by the one or more processors 3210, cause the one or more processors 3210 to perform the method 3000 described with respect to FIG. 30, or any aspect related to it. Note that reference to a processor performing a function of device 3200 may include one or more processors performing that function of device 3200.

In the depicted example, computer-readable medium/memory 3212 stores code (e.g., executable instructions) for detecting 3230, code for applying 3232, code for masking 3234, code for obtaining 3236, code for sending 3238, and code for generating 3240. Processing of the code 3230-3240 may cause the imaging device 3200 to perform the method 3000 described with respect to FIG. 30, or any aspect related to it.

The one or more processors 3210 include circuitry configured to implement (e.g., execute) the code stored in the computer-readable medium/memory 3212, including circuitry for detecting 3218, circuitry for applying 3220, circuitry for masking 3222, circuitry for obtaining 3224, circuitry for sending 3226, and circuitry for generating 3228. Processing with circuitry 3218-3228 may cause the imaging device 3200 to perform the method 3100 described with respect to FIG. 31, or any aspect related to it.

Various components of the device 3200 may provide means for performing the method 3000 described with respect to FIG. 30, or any aspect related to it. Various components of the device 3200 may provide means for performing the method 3100 described with respect to FIG. 31, or any aspect related to it.

The device 3200 includes a GPU processing system 3206. The GPU processing system 3206 may be configured to perform processing functions for the device 2000, including multiscale imaging of porous media generated by the device 3200.

The GPU processing system 3206 includes one or more processors 3214. The one or more processors 3214 are coupled to a computer-readable medium/memory 3216 via a bus. The one or more processors 3214 and the computer-readable medium/memory 3216 may communicate with the one or more processor 3210 and the computer-readable medium/memory 3212 of the CPU processing system 3204 via an MPI 3208. In certain aspects, the computer-readable medium/memory 3216 is configured to store instructions (e.g., computer-executable code) that when executed by the one or more processors 3214, cause the one or more processors 3214 to perform the method 3100 described with respect to FIG. 31, or any aspect related to it. Note that reference to a processor performing a function of device 3200 may include one or more processors performing that function of device 3200.

In the depicted example, computer-readable medium/memory 3216 stores code (e.g., executable instructions) for obtaining/receiving 3252, code for applying 3254, code for generating 3256, code for sending/outputting 3258, and code for decomposing 3260. Processing of the code 3252-3260 may cause the imaging device 3200 to perform the method 3100 described with respect to FIG. 31, or any aspect related to it.

The one or more processors 3214 include circuitry configured to implement (e.g., execute) the code stored in the computer-readable medium/memory 3216, including circuitry for obtaining/receiving 3242, circuitry for applying 3244, circuitry for generating 3246, circuitry for sending/outputting 3248, and circuitry for decomposing 3250. Processing with circuitry 3242-3250 may cause the imaging device 3200 to perform the method 3100 described with respect to FIG. 31, or any aspect related to it.

Various components of the imaging device 3200 may provide means for performing the method 3200 described with respect to FIG. 31, or any aspect related to it.

### Example Aspects

Implementation examples are described in the following numbered clauses:

Aspect 1: A method for image processing by one or more central processing units (CPU), comprising: obtaining a set of images of at least one porous media sample; applying at least one of adaptive local thresholding, automated global thresholding, and morphological operations to one or more of the set of images; based on the applying, masking a set of macro-pores within the at least one porous media sample using an estimate of the set of macro-pores, wherein the estimate for each of the set of macro-pores represents a segment of the at least one porous media sample; obtaining a set of clusters generated based, at least in part, on the masking; and applying a marker-controlled watershed segmentation procedure to the set of clusters.

Aspect 2: The method of aspect 1, wherein the porous media sample is a digital rock sample.

Aspect 3: A method for image processing by one or more graphics processing units (GPU), comprising: receiving a set of masked macro-pores representing a segment of at least one porous media sample; applying a clustering-based segmentation model to the set of masked macro-pores to generate cluster centroid values associated with each of a pixel within the porous media sample; outputting the cluster centroid values.

Aspect 4: The method of aspect 3, wherein the porous media sample is a digital rock sample.

Aspect 5: A non-transitory computer-readable medium comprising computer-executable instructions that, when executed by one or more processors, cause one or more central processing units (CPUs) to: obtain a set of images of at least one porous media sample; apply at least one of adaptive local thresholding, automated global thresholding, and morphological operations to one or more of the set of images; based on the application, mask a set of macro-pores within the at least one porous media sample using an estimate of the set of macro-pores, wherein the estimate for each of the set of macro-pores represents a segment of the at least one porous media sample; obtain a set of clusters generated based, at least in part, on the masking; and apply a marker-controlled watershed segmentation procedure to the set of clusters.

Aspect 6: A non-transitory computer-readable medium comprising computer-executable instructions that, when executed by one or more processors, cause one or more graphics processing units (GPUs) to: receive a set of masked macro-pores representing a segment of at least one porous media sample; apply a clustering-based segmentation model to the set of masked macro-pores to generate cluster centroid values associated with each of a pixel within the porous media sample; output the cluster centroid values.

Aspect 7: An apparatus, comprising: a memory comprising executable instructions; and a processor configured to execute the executable instructions and cause the apparatus to perform a method in accordance with any one of Aspects 1-6.

Aspect 8: An apparatus, comprising means for performing a method in accordance with any one of Aspects 1-6.

Aspect 9: A non-transitory computer-readable medium comprising executable instructions that, when executed by a processor of an apparatus, cause the apparatus to perform a method in accordance with any one of Aspects 1-6.

Aspect 10: A computer program product embodied on a computer-readable storage medium comprising code for performing a method in accordance with any one of Aspects 1-6.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, decomposing, and the like.

The methods disclosed herein comprise one or more operations or actions for achieving the methods. The method operations and/or actions may be interchanged with one another without departing from the scope of the claims. In other words, unless a specific order of operations or actions is specified, the order and/or use of specific operations and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in the Figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for image processing by one or more central processing units (CPU), comprising:
obtaining a set of images of at least one porous media sample;
applying at least one of adaptive local thresholding, automated global thresholding, and morphological operations to one or more images of the set of images;
based on the applying, masking a set of macro-pores within the at least one porous media sample using an estimate of the set of macro-pores, wherein the estimate for each of the set of macro-pores represents a segment of the at least one porous media sample;
obtaining a set of clusters generated based, at least in part, on the masking; and
applying a marker-controlled watershed segmentation procedure to the set of clusters.

2. The method of claim 1, wherein the porous media sample is a digital rock sample.

3. The method of claim 1, further comprising:
filtering the set of images using a top-hat transform filter to form a top-hat transformation; and
applying an automatic Otsu thresholding to binarize the top-hat transformation.

4. The method of claim 1, wherein the morphological operations comprise:
dilating and eroding the set of images;
subjecting the set of images to an OR bitwise operation;
subjecting the set of images to a component analysis; and
performing an AND bitwise operation.

5. The method of claim 1, further comprising:
an image processing platform comprising an interpolation scheme between a previously identified Modeₚₒᵣₑ and Mode_{grain} as a first endpoint and a second endpoint, wherein the with Modeₚₒᵣₑ associated with 100% micro-porosity and the Mode_{grain} associated with 0% micro-porosity, and wherein intensity in between the Modeₚₒᵣₑ and Mode_{grain} being mapped to a corresponding micro-porosity according to the equation
$${p}^{*} = \frac{100}{{Mode}_{pore} - {Mode}_{grain}} ( p - {Mode}_{grain} ) .$$

6. A non-transitory computer-readable medium comprising computer-executable instructions that, when executed by one or more processors, cause one or more central processing units (CPUs) to:
obtain a set of images of at least one porous media sample;
apply at least one of adaptive local thresholding, automated global thresholding, and morphological operations to one or more of the set of images;
based on the applying, mask a set of macro-pores within the at least one porous media sample using an estimate of the set of macro-pores, wherein the estimate for each of the set of macro-pores represents a segment of the at least one porous media sample;
obtain a set of clusters generated based, at least in part, on a masking; and
apply a marker-controlled watershed segmentation procedure to the set of clusters.

7. The non-transitory computer readable medium of claim 6, wherein the porous media sample is a digital rock sample.

8. The non-transitory computer readable medium of claim 6, further comprising:
filtering the set of images using a top-hat transform filter to form a top-hat transformation; and
applying an automatic Otsu thresholding to binarize the top-hat transformation.

9. The non-transitory computer readable medium of claim 6, wherein the morphological operations comprise:
dilating and eroding the set of images;
subjecting the set of images to an OR bitwise operation;
subjecting the set of images to a component analysis; and
performing an AND bitwise operation.

10. The non-transitory computer readable medium of claim 6, further comprising:
an image processing platform comprising an interpolation scheme between a previously identified Modeₚₒᵣₑ and Mode_{grain} as a first endpoint and a second endpoint, wherein the with Modeₚₒᵣₑ associated with 100% micro-porosity and the Mode_{grain} associated with 0% micro-porosity, and wherein intensity in between the Modeₚₒᵣₑ and Mode_{grain} being mapped to a corresponding micro-porosity according to the equation
$${p}^{*} = \frac{100}{{Mode}_{pore} - {Mode}_{grain}} ( p - {Mode}_{grain} ) .$$

11. An apparatus for image processing comprising a memory and one or more central processing units (CPU), the one or more CPUs configured to cause the apparatus to:
obtain a set of images of at least one porous media sample;
apply at least one of adaptive local thresholding, automated global thresholding, and morphological operations to one or more of the set of images;
based on the applying, mask a set of macro-pores within the at least one porous media sample using an estimate of the set of macro-pores, wherein the estimate for each of the set of macro-pores represents a segment of the at least one porous media sample;
obtain a set of clusters generated based, at least in part, on a masking; and
apply a marker-controlled watershed segmentation procedure to the set of clusters.

12. The apparatus of claim 11, wherein the porous media sample is a digital rock sample.

13. The apparatus of claim 11, further comprising:
filtering the set of images using a top-hat transform filter to form a top-hat transformation; and
applying an automatic Otsu thresholding to binarize the top-hat transformation.

14. The apparatus of claim 11, wherein the morphological operations comprise:
dilating and eroding the set of images;
subjecting the set of images to an OR bitwise operation;
subjecting the set of images to a component analysis; and
performing an AND bitwise operation.

15. The apparatus of claim 11, further comprising:
an image processing platform comprising an interpolation scheme between a previously identified Modeₚₒᵣₑ and Mode_{grain} as a first endpoint and a second endpoint, wherein the with Modeₚₒᵣₑ associated with 100% micro-porosity and the Mode_{grain} associated with 0% micro-porosity, and wherein intensity in between the Modeₚₒᵣₑ and Mode_{grain} being mapped to a corresponding micro-porosity according to the equation
$${p}^{*} = \frac{100}{{Mode}_{pore} - {Mode}_{grain}} ( p - {Mode}_{grain} ) .$$
